(19) United States
(12) Patent Application Publication
(10) Pub. No.: US 2026/0230856 A1
(43) Pub. Date: Aug. 6, 2026

(54) INDICATION OF A TRAINING DATA SET FOR LIFECYCLE MANAGEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US)

(21) Appl. No.: 19/154,754

(22) PCT Filed: Apr. 7, 2023
(86) PCT No.: PCT/CN2023/086784

§ 371 Date: Aug. 7, 2025

(51) Int. Cl. H04W 24/04; G06N 20/00

(52) U.S. Cl. CPC H04W 24/04; G06N 20/00

(57) ABSTRACT

Methods, systems, and devices for wireless communication are described. A user equipment (UE) may receive control information from a network entity. The control information may be indicative of a characteristic of a data set used for training machine learning (ML) models at the UE. The UE may determine to activate or deactivate a first ML model for maintaining a wireless communication link based on receiving the control information. Alternatively, the UE may determine to validate or invalidate a functionality of a second ML model for maintaining the wireless communication link based on receiving the control information. The UE may transmit feedback information based on determining to activate or deactivate the first ML model or validate or invalidate the functionality of the second ML model. The feed-Entity back information may be indicative of one or more parameters of the first ML model or the functionality of the second ML model.

### CROSS REFERENCE

The present Application for Patent is a 371 national phase filing of International Patent Application No. PCT/CN2023/086784 by LI et al., entitled “INDICATION OF A TRAINING DATA SET FOR LIFECYCLE MANAGEMENT,” filed Apr. 7, 2023, assigned to the assignee hereof, and expressly incorporated by reference herein.

### FIELD OF TECHNOLOGY

The following relates to wireless communication, including indication of a training data set for lifecycle management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). In some wireless communications systems, the communication devices may support artificial intelligence (AI) or machine learning (ML). In some cases, existing techniques for managing lifecycles of AI or ML (AI/ML) models may be deficient.

### SUMMARY

The described techniques relate to improved methods, systems, devices, and apparatuses that support indication of a training data set for lifecycle management (LCM). For example, the described techniques provide a framework for indicating characteristics associated with training data set to achieve machine learning (ML) model activation or deactivation or functionality validation or invalidation. In some examples, a user equipment (UE) may receive control information from a network entity. The control information may be indicative of a characteristic of a data set used for training ML models at the UE. In some examples, the ML models may be associated with maintaining a wireless communication link. The UE may determine to activate or deactivate a first ML model for maintaining the wireless communication link based on receiving the control information. Alternatively, the UE may determine to validate or invalidate a functionality of a second ML model for maintaining the wireless communication link based on receiving the control information. The UE may transmit feedback information to the network entity based on determining to activate or deactivate the first ML model or validate or invalidate the functionality of the second ML model. The feedback information may be indicative of one or more parameters of the first ML model or the functionality of the second ML model.

A method for wireless communications at a UE is described. The method may include receiving, from a network entity, control information indicative of a characteristic of a data set used for training ML models at the UE, the ML models associated with maintaining a wireless communication link, determining to activate or deactivate a first ML model for maintaining the wireless communication link or validate or invalidate a functionality of a second ML model for maintaining the wireless communication link based on receiving the control information, and transmit, to the network entity, feedback information indicative of one or more parameters of the first ML model or the functionality of the second ML model based on the determining.

An apparatus for wireless communications at a UE is described. The apparatus may include a processor, memory coupled with the processor, and instructions stored in the memory. The instructions may be executable by the processor to cause the apparatus to receive, from a network entity, control information indicative of a characteristic of a data set used for training ML models at the UE, the ML models associated with maintaining a wireless communication link, determine to activate or deactivate a first ML model for maintaining the wireless communication link or validate or invalidate a functionality of a second ML model for maintaining the wireless communication link based on receiving the control information, and transmit, to the network entity, feedback information indicative of one or more parameters of the first ML model or the functionality of the second ML model based on the determining.

Another apparatus for wireless communications at a UE is described. The apparatus may include means for receiving, from a network entity, control information indicative of a characteristic of a data set used for training ML models at the UE, the ML models associated with maintaining a wireless communication link, means for determining to activate or deactivate a first ML model for maintaining the wireless communication link or validate or invalidate a functionality of a second ML model for maintaining the wireless communication link based on receiving the control information, and means for transmit, to the network entity, feedback information indicative of one or more parameters of the first ML model or the functionality of the second ML model based on the determining.

A non-transitory computer-readable medium storing code for wireless communications at a UE is described. The code may include instructions executable by a processor to receive, from a network entity, control information indicative of a characteristic of a data set used for training ML models at the UE, the ML models associated with maintaining a wireless communication link, determine to activate or deactivate a first ML model for maintaining the wireless communication link or validate or invalidate a functionality of a second ML model for maintaining the wireless communication link based on receiving the control information, and transmit, to the network entity, feedback information indicative of one or more parameters of the first ML model or the functionality of the second ML model based on the determining.

In some examples of the method, apparatuses, and non-transitory computer-readable medium described herein, receiving the control information may include operations, features, means, or instructions for receiving a data set identifier (ID) corresponding to the data set or a characteristic ID corresponding to the characteristic, or both.

Some examples of the method, apparatuses, and non-transitory computer-readable medium described herein may further include operations, features, means, or instructions for transmitting, to the network entity, an uplink message including one or more data set IDs corresponding to one or more recommended data sets, one or more characteristic IDs corresponding to one or more recommended characteristics, or both, where the control information may be based on the uplink message.

In some examples of the method, apparatuses, and non-transitory computer-readable medium described herein, the one or more data set IDs includes at least the data set ID and the one or more characteristic IDs includes at least the characteristic ID.

In some examples of the method, apparatuses, and non-transitory computer-readable medium described herein, the characteristic includes an operation scenario for the wireless communication link, a profile characteristics of the wireless communication link, a parameter of a cell serving the wireless communication link, a transmit parameter used for downlink communications via the wireless communication link, a transmit parameter used for uplink communications via the wireless communication link, or a distance between the network entity and the UE.

In some examples of the method, apparatuses, and non-transitory computer-readable medium described herein, the first ML model and the second ML model each include a respective beam prediction ML model based on the data set being used for training beam prediction ML modes.

In some examples of the method, apparatuses, and non-transitory computer-readable medium described herein, the characteristic includes a statistic associated with received power measurements used as input for the ML models, a statistic associated with received power measurements used as a prediction target for the ML models, a performance metric associated with the received power measurements used as the input for the ML models, a performance metric associated with the received power measurements used as the prediction target for the ML models, a UE mobility characteristic, a characteristic of a transmit beam at the network entity, or a characteristic of a receive beam at the UE.

In some examples of the method, apparatuses, and non-transitory computer-readable medium described herein, receiving the control information may include operations, features, means, or instructions for receiving radio resource control (RRC) layer signaling, physical (PHY) layer signaling, medium access control (MAC) layer signaling, or application layer signaling that includes the control information.

In some examples of the method, apparatuses, and non-transitory computer-readable medium described herein, transmitting the feedback information may include operations, features, means, or instructions for transmitting an indication of a correspondence between the one or more parameters and the characteristic.

Some examples of the method, apparatuses, and non-transitory computer-readable medium described herein may further include operations, features, means, or instructions for identifying the one or more parameters in response to the determining and based on the correspondence between the one or more parameters and the characteristic, where the feedback information indicates activation or deactivation of the first ML model at the UE or validation or invalidation of the functionality of the second ML model at the UE.

In some examples of the method, apparatuses, and non-transitory computer-readable medium described herein, transmitting the feedback information may include operations, features, means, or instructions for transmitting an indication of the one or more parameters.

Some examples of the method, apparatuses, and non-transitory computer-readable medium described herein may further include operations, features, means, or instructions for activating or deactivating the first ML model in association with the characteristic of the data set.

Some examples of the method, apparatuses, and non-transitory computer-readable medium described herein may further include operations, features, means, or instructions for predicting a transmit beam at the network entity or a receive beam at the UE for maintaining the wireless communication link using the first ML model based on activating the first ML model, where the data set may be used for training beam prediction ML models.

Some examples of the method, apparatuses, and non-transitory computer-readable medium described herein may further include operations, features, means, or instructions for validating or invalidating the functionality of the second ML model in association with the characteristic of the data set.

Some examples of the method, apparatuses, and non-transitory computer-readable medium described herein may further include operations, features, means, or instructions for predicting a transmit beam at the network entity or a receive beam at the UE for maintaining the wireless communication link using the second ML model based on validating the functionality of the second ML model, where the data set may be used for training beam prediction ML models.

A method for wireless communications at a network entity is described. The method may include outputting control information indicative of a characteristic of a data set used for training ML models at a UE, the ML models associated with maintaining a wireless communication link and obtaining, in response to the control information, feedback information indicative of one or more parameters of a first ML model or a functionality of a second ML model based on a determination to activate or deactivate the first ML model for maintaining the wireless communication link or validate or invalidate a functionality of the second ML model for maintaining the wireless communication link.

An apparatus for wireless communications at a network entity is described. The apparatus may include a processor, memory coupled with the processor, and instructions stored in the memory. The instructions may be executable by the processor to cause the apparatus to outputting control information indicative of a characteristic of a data set used for training ML models at a UE, the ML models associated with maintaining a wireless communication link and obtain, in response to the control information, feedback information indicative of one or more parameters of a first ML model or a functionality of a second ML model based on a determination to activate or deactivate the first ML model for maintaining the wireless communication link or validate or invalidate a functionality of the second ML model for maintaining the wireless communication link.

Another apparatus for wireless communications at a network entity is described. The apparatus may include means for outputting control information indicative of a characteristic of a data set used for training ML models at a UE, the ML models associated with maintaining a wireless communication link and means for obtaining, in response to the control information, feedback information indicative of one or more parameters of a first ML model or a functionality of a second ML model based on a determination to activate or deactivate the first ML model for maintaining the wireless communication link or validate or invalidate a functionality of the second ML model for maintaining the wireless communication link.

A non-transitory computer-readable medium storing code for wireless communications at a network entity is described. The code may include instructions executable by a processor to outputting control information indicative of a characteristic of a data set used for training ML models at a UE, the ML models associated with maintaining a wireless communication link and obtain, in response to the control information, feedback information indicative of one or more parameters of a first ML model or a functionality of a second ML model based on a determination to activate or deactivate the first ML model for maintaining the wireless communication link or validate or invalidate a functionality of the second ML model for maintaining the wireless communication link.

In some examples of the method, apparatuses, and non-transitory computer-readable medium described herein, outputting the control information may include operations, features, means, or instructions for outputting a data set ID corresponding to the data set or a characteristic ID corresponding to the characteristic, or both.

Some examples of the method, apparatuses, and non-transitory computer-readable medium described herein may further include operations, features, means, or instructions for obtaining an uplink message including one or more data set IDs corresponding to one or more recommended data sets, one or more characteristic IDs corresponding to one or more recommended characteristics, or both, where the control information may be based on the uplink message.

In some examples of the method, apparatuses, and non-transitory computer-readable medium described herein, the one or more data set IDs includes at least the data set ID and the one or more characteristic IDs includes at least the characteristic ID.

In some examples of the method, apparatuses, and non-transitory computer-readable medium described herein, the characteristic includes an operation scenario for the wireless communication link, a profile characteristics of the wireless communication link, a parameter of a cell serving the wireless communication link, a transmit parameter used for downlink communications via the wireless communication link, a transmit parameter used for uplink communications via the wireless communication link, or a distance between the network entity and the UE.

In some examples of the method, apparatuses, and non-transitory computer-readable medium described herein, the first ML model and the second ML model each include a respective beam prediction ML model based on the data set being used for training beam prediction ML modes.

In some examples of the method, apparatuses, and non-transitory computer-readable medium described herein, the characteristic includes a statistic associated with received power measurements used as input for the ML models, a statistic associated with received power measurements used as a prediction target for the ML models, a performance metric associated with the received power measurements used as the input for the ML models, a performance metric associated with the received power measurements used as the prediction target for the ML models, a UE mobility characteristic, a characteristic of a transmit beam at the network entity, or a characteristic of a receive beam at the UE.

In some examples of the method, apparatuses, and non-transitory computer-readable medium described herein, outputting the control information may include operations, features, means, or instructions for outputting RRC layer signaling, PHY layer signaling, MAC layer signaling, or application layer signaling that includes the control information.

In some examples of the method, apparatuses, and non-transitory computer-readable medium described herein, obtaining the feedback information may include operations, features, means, or instructions for obtaining an indication of a correspondence between the one or more parameters and the characteristic.

In some examples of the method, apparatuses, and non-transitory computer-readable medium described herein, obtaining the feedback information may include operations, features, means, or instructions for obtaining an indication of the one or more parameters.

### BRIEF DESCRIPTION OF THE DRAWINGS

FIGS. 1 and 2 each show an example of a wireless communications system that supports indication of a training data set for lifecycle management (LCM) in accordance with one or more aspects of the present disclosure.

FIG. 3 shows an example of a process flow that supports indication of a training data set for LCM in accordance with one or more aspects of the present disclosure.

FIGS. 4 and 5 show block diagrams of devices that support indication of a training data set for LCM in accordance with one or more aspects of the present disclosure.

FIG. 6 shows a block diagram of a communications manager that supports indication of a training data set for LCM in accordance with one or more aspects of the present disclosure.

FIG. 7 shows a diagram of a system including a device that supports indication of a training data set for LCM in accordance with one or more aspects of the present disclosure.

FIGS. 8 and 9 show block diagrams of devices that support indication of a training data set for LCM in accordance with one or more aspects of the present disclosure.

FIG. 10 shows a block diagram of a communications manager that supports indication of a training data set for LCM in accordance with one or more aspects of the present disclosure.

FIG. 11 shows a diagram of a system including a device that supports indication of a training data set for LCM in accordance with one or more aspects of the present disclosure.

FIGS. 12 and 13 show flowcharts illustrating methods that support indication of a training data set for LCM in accordance with one or more aspects of the present disclosure.

### DETAILED DESCRIPTION

Some wireless communications systems may support artificial intelligence or machine learning (AI/ML) at one or more communication devices, such as user equipments (UEs). For example, a UE may support one or more AI/ML models for various functionalities, such as beam predictions for beam management. In some examples, a network entity associated with the UE may enable (or otherwise support) AI/ML model lifecycle management (LCM) at the UE. For example, the network entity may monitor a performance of the UE or one or more AI/ML models deployed at the UE. In some examples, such as based on the performance monitoring, the network entity may make determinations regarding selection, activation, or deactivation of AI/ML models deployed at the UE. Additionally, or alternatively, based on the performance monitoring, the network may make determinations regarding selection, validation, or invalidation of functionalities that the UE may use AI/ML models for.

In some examples, the network entity and the UE may support model-based LCM for AI/ML, in which the network entity may obtain information associated with AI/ML models at the UE, such as parameters and structures of the AI/ML models. The network entity may use the information obtained for the AI/ML models to make determinations, and to instruct the UE, to activate or deactivate an AI/ML model. For example, the network entity may indicate, to the UE, to activate or deactivate an AI/ML model based on (or using) information the network entity obtained for the AI/ML model. In some examples, however, model-based LCM may lead to sensitive information being disclosed to the network entity. In some other examples, the UE and the network entity may support functionality-based LCM for AI/ML, in which the network entity may instruct the UE to activate or deactivate an AI/ML model by indicating, to the UE, to validate or invalidate a functionality. In other words, the network entity may achieve AI/ML model activation or deactivation by indicating functionality validation or invalidation. In such examples, the UE may reduce a likelihood of (e.g., avoid) sensitive information being disclosed to the network entity. In some examples, however, aspects of a functionality (e.g., how functionalities are defined) may be unclear to the UE or the network entity, or both. As such, indicating functionality validation or invalidation may be ambiguous to the UE, which may degrade a performance of LCM at the UE.

Various aspects of the present disclosure related to techniques for indication of a training data set for LCM and, more specifically, to a framework for indicating characteristics associated with training data set to achieve AI/ML model activation or deactivation or functionality validation or invalidation. For example, an AI/ML model deployed at the UE for a functionality may be associated with a data set used to train the AI/ML model (e.g., a training data set). That is, AI/ML models and functionalities of the AI/ML models may be associated with data sets used to train the AI/ML models. As such, the network entity may use characteristics of a data set used to train an AI/ML model to instruct the UE to activate or deactivate the AI/ML model or to validate or invalidate a functionality of the AI/ML model. For example, the UE may receive control information indicative of a characteristic of a data set used for training AI/ML models at the UE. In some examples, such as in response to receiving the control information, the UE may determine to activate or deactivate a first AI/ML model in accordance with the indicated characteristic. Additionally, or alternatively, the UE may determine to validate or invalidate a functionality of a second AI/ML model (e.g., an activated AI/ML model) in accordance with the indicated characteristic. In some examples, the AI/ML models may be associated with one or more functionalities, such as functionalities associated with maintaining a wireless communication link. In some examples, the UE may transmit feedback information to the network entity based on determining to activate or deactivate the first AI/ML model or determining to validate or invalidate the functionality of the second AI/ML model. The feedback information may be indicative of one or more parameters of the first AI/ML model or the functionality of the second AI/ML model.

Aspects of the subject matter described herein may be implemented to realize one or more of the following potential advantages. For example, the techniques employed by the described communication devices may provide benefits and enhancements to the operation of the communication devices, including improve LCM for AI/ML operations at a UE. The operations performed by the described communication devices to improve LCM for AI/ML operations at the UE may include indicating, to the UE, a characteristic of a data set used to train AI/ML models at the UE. In some examples, operations performed by the described communication devices may also support increased reliability of communications within a wireless communications system, among other benefits. Aspects of the disclosure are initially described in the context of a wireless communications systems and a process flow. Aspects of the disclosure are further illustrated by and described with reference to apparatus diagrams, system diagrams, and flowcharts that relate to indication of a training data set for LCM.

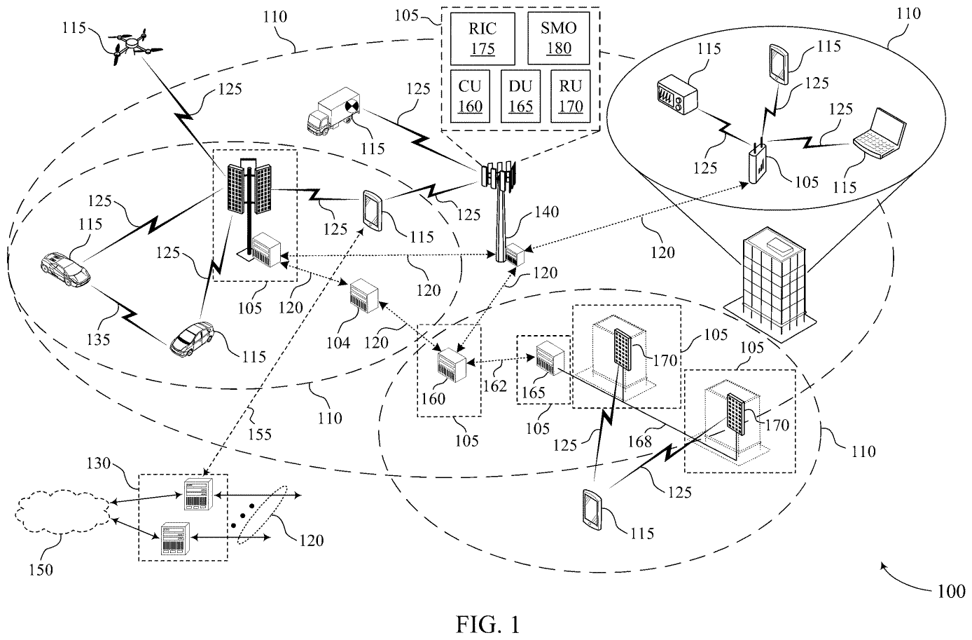

FIG. 1 shows an example of a wireless communications system 100 that supports indication of a training data set for LCM in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support indication of a training data set for LCM as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ.N_{f}) seconds, for which Δfₘₐₓ may represent a supported subcarrier spacing, and Nf may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of the wireless communications system 100, a network entity 105 and a UE 115 may use one or more beam management techniques to improve a capacity of wireless communications between the network entity 105 and the UE 115 (e.g., via the communication link 125). In some examples, the UE 115 and the network entity 105 may use one or more beam management techniques to improve initial access procedures, tracking procedures, and to identify a beam pair for wireless communications between the UE 115 and the network entity 105 (e.g., a gNB). For example, the UE 115 may operate in one or more RRC states, such as an idle state (e.g., indicated via an RRC_IDLE information element (IE)), an inactive state (e.g., indicated via an RRC_inactive IE), or a connected state (e.g., indicated via an RRC_connected IE). In some examples, the network entity 105 and the UE 115 may perform an initial access procedure subsequent to the UE 115 operating in the idle state or inactive state. For example, the network entity 105 may perform a beam sweeping procedure in which the network entity 105 may use one or more of the beams (e.g., relatively wide beams, such as synchronization signal block (SSB) beams) to transmit reference signals (e.g., SSBs) to the UE 115. The UE 115 may use information communicated via one or more of the SSBs to perform an initial access procedure, such as a contention free random access (CFRA) procedure or a contention based random access (CBRA) procedure.

During the initial access procedure, the UE 115 may use one or more random access occasions to transmit a random access preamble to the network entity 105, for example, to establish a connection with the network entity 105.

In some examples, while the UE 115 may be operating in the idle state or inactive state, the UE 115 may use tracking reference signals (TRSs), in which configurations for the TRS may be provided to the UE 115 in system information, such as for paging reception at the UE 115 (e.g., to conserver power). In a cell in which TRS may be available for the UE 115 to use while the UE 115 may be operating in the idle state or the inactive state, an availability of configured TRS may be informed to the UE 115 via signaling, such as L1 signaling (e.g., from the network entity 105).

In some examples, such as examples in which the UE 115 may be operating in the connected state, the UE 115 may receive downlink communications from the network entity 105 via a directional beam, such as may be used to transmit one or more reference signals. In some instances, an established connection (e.g., the communication link 125, which may also be referred to as a radio link or a link) may be susceptible to blockages and degradation, which may cause interruptions in the radio link or a radio link failure. That is, the downlink communications from the network entity 105 may be dropped. To reduce the likelihood of radio link failures occurring or to recover after a radio link failure, the UE 115 may perform one or more beam management procedures, such as a beam failure prevention procedure or a beam failure recovery procedure.

For example, the UE 115 may perform the beam failure recovery procedure to reestablish a connection with the network entity 105 and select another (e.g., different) beam pair for communications with the network entity 105. The beam pair may include a beam of the network entity 105 (e.g., a beam associated with a cell supported by the network entity 105) and a beam of the UE 115. In some examples, the beam management procedures may include one or more processes for downlink beam management, such as beam selection (P1), transmit beam refinement for the network entity 105 (P2), and receive beam refinement for the UE 115 (P3). In some examples, P1, P2, and P3 may include transmission of one or more reference signals from the network entity 105, such as SSBs or CSI-RS. Additionally, the beam management procedures may include one or more other processes for uplink beam management (e.g., U1, U2, U3), which may include transmission of uplink reference signals (e.g., sounding reference signals (SRS)) from the UE 115. In some examples, beam management procedures at the UE 115 or the network entity 105 (or both) may include L1-based (or L2-based) measurement reporting (e.g., L1-RSRP reporting, L1-SINR reporting), transmission configuration indicator (TCI) state configurations (e.g., indications from the network entity 105), component carrier group (CC-group) beam updates, relatively fast uplink beam updates, unified TCI state reporting, L1-centric or L2-centric mobility reporting, dynamic TCI updates, uplink multi-panel selection, and maximum permitted exposure (MPE) mitigation, among other possible examples that may lead to beam management latency reduction. The UE 115 and the network entity 105 may support one or more beam management techniques for high-speed train (HST), single frequency network (SFN), and multiple TRP (mTRP) deployments, among other examples.

In some examples, the UE 115 may detect interruptions in the radio link or detects a radio link failure based on measurements, such as measurements on beam failure detection reference signals (BFD-RSs) or physical downlink control channel (PDCCH) block error rate (BLER) measurements. In such examples, the UE 115 may perform a recovery procedure (e.g., beam failure recovery procedure) to reduce a link interruption time or a link failure time. The recover procedure may be for a primary cell (PCell), primary cell of a secondary cell group (PSCell), or a secondary cell (SCell). In some examples, the recover procedure may be based on a random access procedure (e.g., CFRA). Additionally, in some examples, the recover procedure may include transmission of a link recovery request (e.g., via a scheduling request). In some examples, the recovery procedure may be a MAC control element (MAC-CE) based beam failure recover procedure (e.g., for an SCell).

In some examples, the UE 115 or the network entity 105, or both, may support AI/ML-based beam management. For example, the UE 115 and the network entity 105 may support one or more techniques for predictive beam management using AI/ML. In some examples, the UE 115 (or the network entity 105) may support one or more AI/ML-based beam management techniques for characterization and performance (e.g., baseline performance) evaluations. For example, the UE 115 may support AI/ML-based beam management for performance monitoring. An AI/ML-based beam management technique may include spatial-domain downlink beam predictions. For example, the UE 115 may use AI/ML to predict measurements for a first set of downlink beams (e.g., a prediction target, which may be referred to as set A) based on measurement results (e.g., actual measurements) of reference signals transmitted to the UE 115 using a second set of downlink beams (e.g., a measurement source, which may be referred to as set B). For example, the UE 115 may use AI/ML to predict measurements for a first set of beams (e.g., set A) based on measurement results (e.g., actual measurements) of reference signals transmitted to the UE 115 using a second set of beams (e.g., set B). Predicted measurements and actual measurements may include reference signal received power (RSRP) measurements or signal to interference plus noise (SINR) measurements, among other possible examples of received power measurements. In other words, predicted measurement results and actual measurement results may include received power metrics, such as RSRP values or SINR values. In some examples, one or more beams may be common to set A and set B. For example, the network entity 105 may use one or more beams to transmit the set of reference signals to the UE 115 and the UE 115 may predict measurements for a same one or more beams or a different one or more beams (e.g., based on measurements of the transmitted set of reference signals).

In some examples, in the spatial-domain, set A may correspond to a first set of reference signal resources (e.g., SSB resources or CSI-RS resources) and set B may correspond to a second set of reference signal resources (e.g., CSI-RS resources or SSB resources). That is, for spatial-domain downlink beam predictions, the UE 115 may predict measurements for the first set of reference signal resources (e.g., based on actual measurements of the second set of reference signal resources). A reference signal resource (e.g., each reference signal resource) included in the first set of reference signal resources may correspond to a respective beam included in the first set of beams (e.g., set A). Additionally, the predicted measurements may be based on actual measurements of a set of reference signals transmitted using the second set of reference signal resources. A reference signal resource (e.g., each reference signal resource) included in the second set of reference signal resources may correspond to a respective beam (e.g., used to transmit the corresponding reference signal) included in the second set of beams (e.g., set B). In some other examples, set A may include a subset (e.g., a down-sampled version) of set B. That is, the first set of reference signal resources (e.g., the first set of beams) may include a subset of the second set of reference signal resources (e.g., the second set of beams).

Another AI/ML-based beam management technique may include time-domain downlink beam predictions. For example, the UE 115 may use AI/ML to predict measurements (e.g., RSRP measurements, SINR measurements) for a first set of beams (e.g., set A) based on previous (e.g., historic) measurement results of a second set of beams (e.g., set B). In some examples, set A may correspond to a set of reference signal resources at a first time occasion and set B may correspond to the same set of reference signal resources at a second time occasion (e.g., a previous time occasion). In some other examples, set A may correspond to a first set of reference signal resources and set B may correspond to a second set of reference signal resources that may be different from the first set of refence signals. For example, the second set of reference signals may correspond to SSB resources (e.g., the UE 115 may perform measurements of SSBs transmitted using relatively wide beams) and the first set of reference signals may correspond to CSI-RS resources (e.g., the UE 115 may predict measurements for CSI-RS that may be transmitted using relatively narrow beams). In some examples, beams in set A and set B may be in a same frequency range. That is, the first set of reference signal resources and the second set of reference signal resources may include frequencies within a same frequency range.

In some examples, the UE 115 may be configured to determine a respective quantity of beams (e.g., reference signal resources) to be included in set A and set B.

Additionally, the UE 115 may select set A out of the beams (e.g., reference signal resources) in set B (e.g., according to a fixed pattern, a random pattern). For example, the UE 115 may select set A from set B based on the determined quantity of beams to be included in set A. That is, set A may be a subset of set B. In some examples, the UE 115, may be configured to determine whether set A and set B are to be different (e.g., whether set A may include relatively narrow beams and set B may include relatively wide beams). Accordingly, the UE 115 may determine a quasi co-location (QCL) relationship between beams in set A and beams in set B. In some examples, set A may be for downlink beam predictions and set B may be for downlink beam measurements. Additionally, in some examples, the UE 115 may be configured with one or more codebook constructions of set A and set B.

In some examples, such as for spatial-domain beam predictions, the wireless communications system 100 may support use of a UE-side AI/ML model for beam management that may include L1 signaling from the UE 115 to report information associated with an AI/ML model inference (e.g., prediction) to the network entity 105. In such examples, one or more beams used for downlink communications with the UE 115 may be based on the AI/ML model inference. That is, one or more beams used for downlink communications with the UE 115 may be based on an output of AI/ML model inference at the UE 115. In some examples, the UE 115 may report predicted L1-RSRP measurements (or L1-SINR measurements) corresponding to one or more beams (e.g., one or more reference signal resources).

In some other examples, such as for time-domain predictions, the wireless communications system 100 may support use of a UE-side AI/ML model for beam management that may include LI signaling from the UE 115 to report information associated with an AI/ML model inference to the network entity 105. In such examples, one or more beams (e.g., reference signal resources) at a quantity (N) of future time instances (e.g., time occasions) may be based on the AI/ML model inference. That is, one or more beams used for downlink communications with the UE 115 at a quantity of future time occasions may be based on an output of the AI/ML model inference at the UE 115. In some examples, the UE 115 may be configured with a value of N. Additionally, for time-domain predictions, the wireless communications system 100 may support use of a UE-side AI/ML model for beam management that may include L1 signaling from the UE 115 to report information associated with an AI/ML model inference to the network entity 105. In some examples, one or more beams (e.g., reference signal resources) at a quantity (N) of future time instances (e.g., time occasions) may be based on an output of the AI/ML model inference (e.g., at the UE 115). In some examples, the UE 115 may be configured with a value of N. In some examples, the UE 115 may report may predicted L1-RSRP measurements corresponding to one or more beams (e.g., one or more reference signal resources). In such examples, the UE 115 may also report information regarding a timestamp corresponding to the reported one or more beams (e.g., the reported one or more reference signal resources). The timestamp information may be explicitly or implicitly indicated via a report (e.g., a report used to report information associated with the one or more beams).

In some examples, such as for spatial-domain predictions and for time-domain predictions with a UE-side AI/ML model, the wireless communications system 100 may support model monitoring with potential down-selection. For example, the wireless communications system 100 may support UE-side model monitoring in which the UE 115 may monitor performance metrics associated with the AI/ML model or with wireless communications between the UE 115 and the network entity 105 (or both). In some examples, the UE 115 may make one or more determinations regarding model selection, activation, deactivation, switching, and fallback operations, among other examples. Additionally, or alternatively, the wireless communications system 100 may support network-side model monitoring in which the network entity 105 may monitor performance metrics associated with the AI/ML model or with wireless communications between the UE 115 and the network entity 105 (or both). Additionally, in some examples, the network entity 105 may make one or more determinations regarding model selection, activation, deactivation, switching, and fallback operations, among other examples. The wireless communications system 100 may support hybrid model monitoring in which the UE 115 may monitor one or more performance metrics and the network entity 105 may make one or more determination regarding model selection, activation, deactivation, switching, and fallback operations.

In some examples, such as for spatial-domain predictions or time-domain predictions with a UE-side AI/ML model and network-side model monitoring, the network entity 105 may monitor one or more performance metrics and make one or more determinations regarding model selection, activation, deactivation, switching, and fallback operations. Additionally, in some examples of network-side model monitoring for a network-side AI/ML model (e.g., for spatial-domain predictions and for time-domain predictions), the UE 115 may be configured to perform beam measurements and transmit a report for model monitoring. In some examples, such as for spatial-domain predictions or for time-domain predictions with a network-side AI/ML model, the UE 115 may support one or more L1 beam reporting enhancement for AI/ML model inference. For example, the UE 115 may report measurement results of multiple (e.g., more than 4) beams in one reporting instance. That is, the UE 115 may report measurement results of multiple (e.g., more than 4) reference signal resources in one reporting instance.

In some examples, the UE 115 may use AI/ML to improve the performance of some functionalities, such as beam predictions, at the UE 115. For example, the UE 115 may use AI/ML to make predictions associated with a transmit beam (e.g., a downlink beam) at the network entity 105 and report such predictions to the network entity 105 to improve beam management (e.g., at the network entity 105). The network entity 105 may aid the UE 115 in managing a lifecycle of one or more AI/ML models. That is, the network entity 105 enable (or otherwise support) AI/ML model LCM at the UE 115 by indicating, to the UE 115, to activate or deactivate one or more AI/ML model based on observations at the network entity 105. For example, the network entity 105 may indicate, to the UE 115, to activate or deactivate an AI/ML model used at the UE 115 for beam predictions. In some examples, however, to enable the network entity 105 to instruct the UE 115 to activate or deactivate an AI/ML model, the UE 115 may provide information associated with the AI/ML model to the network entity 105, which may lead to reduced security at the UE 115. In other words, enabling model-based LCM for AI/ML operations at the UE 115 may lead to the disclosure of sensitive information to the network entity 105.

In some other examples, the network entity 105 may indicate, to the UE 115, to validate or invalidate a functionality at the UE 115. For example, the network entity 105 enable (or otherwise support) AI/ML model LCM at the UE 115 by indicating, to the UE 115, to validate or invalidate a functionality (e.g., beam predictions), which may lead to the UE 115 activating or deactivating an AI/ML model used for the functionality (e.g., used for beam predictions at the UE 115). In such examples, the network entity 105 may achieve activation or deactivation of an AI/ML model and the UE 115 may reduce a likelihood of (e.g., avoid) sensitive information being disclosed to the network entity 105. In some examples, however, aspects of a functionality (e.g., how functionalities are defined) may be unclear to the UE 115 or the network entity 105, or both. For example, an indication of a functionality may be ambiguous to the UE 115. As such, using validation or invalidation of a functionality to achieve activation or deactivation of an AI/ML model may be relatively ineffective and degrade LCM of AI/ML models at the UE.

In some examples of the wireless communications system 100, the UE 115 and the network entity 105 may support a framework for indicating characteristics associated with training data set to achieve AI/ML model activation or deactivation or functionality validation or invalidation. For example, the UE 115 may receive control information from the network entity 105. The control information may be indicative of a characteristic of a data set used for training AI/ML models at the UE 115. In some examples, the AI/ML models may be associated with maintaining a wireless communication link. The UE 115 may determine to activate or deactivate a first AI/ML model for maintaining the wireless communication link based on receiving the control information. Alternatively, the UE 115 may determine to validate or invalidate a functionality of a second AI/ML model for maintaining the wireless communication link based on receiving the control information. The UE 115 may transmit feedback information to the network entity 105 based on determining to activate or deactivate the first AI/ML model or validate or invalidate the functionality of the second AI/ML model. The feedback information may be indicative of one or more parameters of the first AI/ML model or the functionality of the second AI/ML model.

In some examples, indication of a training data set for LCM, as described herein, may provide improvements to beam management at the UE 115 or the network entity 105 (or both). For example, one or more aspects of adaptive CSI reporting for predictive beam management may provide a framework for AI/ML beam predictions for the air-interface (e.g., wireless communications) that may lead to increased performance and reduced complexity (e.g., for beam management). The framework may include beam predictions in time-domain or spatial-domain (or both), which may provide for overhead and latency reduction and beam selection accuracy improvements. In some examples, the framework may enable use of AI/ML for characterization and baseline performance evaluations. Accordingly, the framework may provide for AI/ML approaches that may be relatively diverse and support constraints on collaboration levels between the UE 115 and the network entity 105. In some examples, indication of a training data set for LCM, as described herein, may provide for characterization of LCM of an AI/ML model including model training, model deployment, model inference, model monitoring, model updating. In other words, adaptive CSI reporting for predictive beam management may be used for AI-based beam prediction performance monitoring.

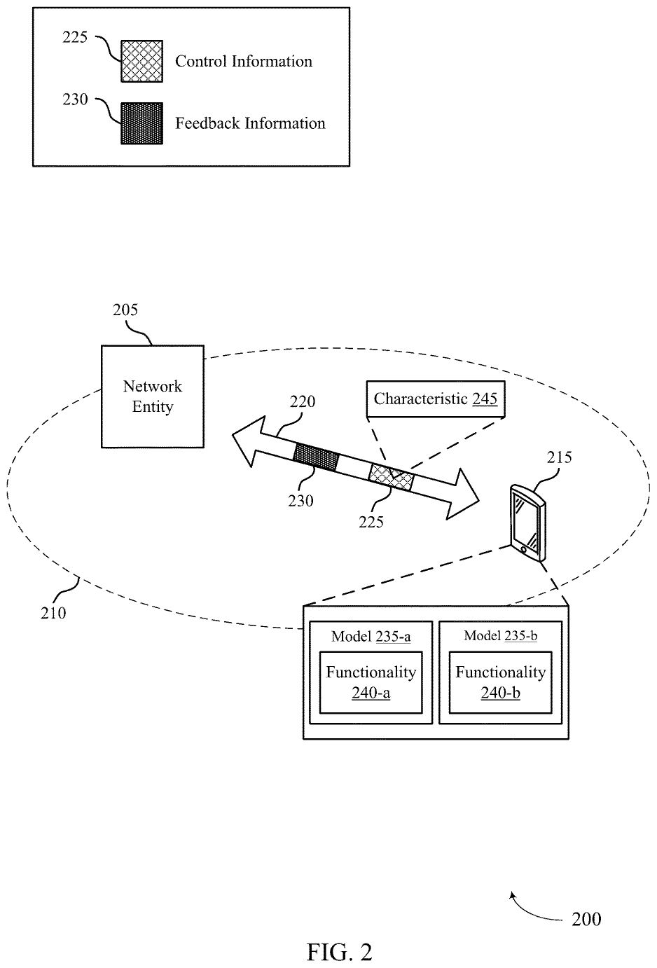

FIG. 2 shows an example of a wireless communications system 200 that supports indication of a training data set for LCM in accordance with one or more aspects of the present disclosure. In some examples, the wireless communications system 200 may implement or be implemented at one or more aspects of the wireless communications system 100. For example, the wireless communications system 200 may include a UE 215, which may be an example of a UE 115 (or another network node) illustrated by and described with reference to FIG. 1. The wireless communications system 200 may also include a network entity 205, which may be an example of one or more of the network entities 105 (e.g., a CU, a DU, an RU, a base station, an IAB node, or one or more other network nodes) illustrated by and described with reference to FIG. 1. The UE 215 and the network entity 205 may communicate with a coverage area 210, which may be an example of a coverage area 110 illustrated by and described with reference to FIG. 1. For example, the UE 215 and the network entity 205 may communicate within the coverage area 210 via a communication link 220, which may be an example of a communication link 125 (e.g., a Uu link) illustrated by and described with reference to FIG. 1.

The wireless communications system 200 may support UE-side AI/ML models (e.g., AI/ML models deployed at the UE 215) for one or more functionalities, such as beam management. For example, the UE 215 may support AI/ML models for time-domain beam predictions and spatial-domain beam predictions, among other examples. In some examples, the UE 215 or the network entity 205, or both, may monitor a performance (e.g., one or more performance metrics) of the UE 215 or of AI/ML models deployed at the UE 215. In such examples (e.g., based on the monitoring), the network entity 205 or the UE 215, or both, may make one or more determinations regarding AI/ML model selection, activation, deactivation, switching, and fallback operations (e.g., fall back operations at the UE 215 regarding one or more AI/ML models). Additionally, or alternatively, the UE 215 or the network entity 205, or both, may (e.g., based on monitor a performance of the UE 215 or of AI/ML models at the UE 215) make one or more determinations regarding functionality selection, validation, invalidation, switching, and fallback operations. In other words, the UE 215 and the network entity 205 may support LCM for AI/ML operations at the UE 215 (e.g., for UE-side model LCM).

For example, the UE 215 and the network entity 205 may support model-based LCM for AI/ML operations at the UE 215. In some examples, such as to support model-based LCM, the network entity 205 may obtain information associated with AI/ML models at the UE 215. For example, the network entity 205 may obtain information associated with parameters and structures of the AI/ML models or data sets used to train the AI/ML models, or both. For example, the network entity 205 may be configured with an association (e.g., correspondence, mapping) between information (e.g., parameter or structure information) associated with one or more AI/ML models deployed at the UE 215, one or more identifiers (IDs) corresponding to the one or more AI/ML models, or one or more functionalities associated with the AI/ML models, or any combination thereof. The one or more functionalities may include one or more scenarios, one or more UE capabilities, or other information or parameters that may be associated with the AI/ML models deployed at the UE 215.

In some examples, the network entity 205 may use information (e.g., the parameter or structure information, the IDs, the functionalities) obtained for the AI/ML models to make determinations (and to instruct the UE 215) to activate, deactivate, or switch an AI/ML model. That is, the network entity 205 may instruct the UE 215 to activate, deactivate, or switch an AI/ML model (e.g., a particular AI/ML model) for a functionality. In other words, the network entity 205 may instruct the UE 215 to activate, deactivate, or switch an AI/ML model for a task, such as beam prediction. For example, the UE 215 may be configured to make predictions in accordance with a first time increment (e.g., 20 ms) and a second time increment (e.g., 200 ms). In such an example, the network entity 205 may instruct the UE 215 to use a first AI/ML model to make predictions in accordance with the first time increment and a second AI/ML model to make predictions in accordance with the second time increment. For example, the network entity 205 may indicate, to the UE 215, a first AI/ML model ID corresponding to the first AI/ML model to use for predictions in accordance with the first time increment (e.g., to use for a first functionality, to use for a first task) and a second AI/ML model ID corresponding to the second AI/ML model to use for predictions in accordance with the second time increment (e.g., to use for a second functionality, to use for a second task). That is, the UE 215 and the network entity 205 may support model-based LCM in which the network entity 205 may obtain information associated with (e.g., may be transparent to, partially aware of, fully aware of) one or more AI/ML models deployed at the UE 215. As such, the AI/ML models may be activated, deactivated, or switched by the network entity 205 (e.g., directly, such as via signaling). In some examples, however, providing the network entity 205 with information associated with AI/ML models deployed at the UE 215, may lead to reduced security at the UE 215 (e.g., due to a possible disclosure of sensitive information). In other words, model-based LCM may lead to sensitive information (e.g., UE proprietary information) being disclosed to the network entity 205.

In some other examples, the UE 215 and the network entity 205 may support functionality-based LCM for AI/ML operations at the UE 215. For example, the UE 215 may support (e.g., enable, use, participate in) one or more functionalities, which may be associated with one or more AI/ML models. That is, the UE 215 may use AI/ML for one or more functionalities. In some examples, a functionality may include (or be otherwise associated with) sub-functionalities and sub-sub-functionalities. That is, the UE 215 may support functionalities with multiple levels (e.g., multi-level functionalities). For example, the UE 215 may support a beam prediction functionality, which may include one or more sub-functionalities, such as spatial-domain beam predictions and time-domain beam predictions. In some examples, functionalities may include UE capability features or conditions associated with (e.g., above) UE capability features, such as over-the-air (OTA) conditions that may trigger a functionality or lead to a functionality being validated. In other words, a functionality may include a UE capability is unreported to the network entity 205 (e.g., beyond UE-reported capabilities), such as UE mobile situations, speed information, or channel profile information, among other examples.

In some examples, such as for functionality-based LCM, the UE 215 may reduce a likelihood of information associated with AI/ML models deployed at the UE 215 being disclosed to the network entity 205. In such examples, the network entity 205 may lack control of AI/ML models deployed at the UE 215. In other words, the network entity 205 may support functionality-based LCM, in which AI/ML features (or AI/ML use cases) may be defined as functionalities (e.g., multi-level functionalities). In such examples, the network entity 205 may instruct (e.g., implicitly instruct) the UE 215 to activate, deactivate, or switch an AI/ML model by indicating (e.g., explicitly indicating), to the UE 215, to validate, invalidate, or switch a functionality. In other words, an AI/ML model activation, deactivation, or switch may be achieved through a functionality validation, functionality invalidation, or functionality switch. For example, the network entity 205 may indicate, to the UE 215, to validate or invalidate beam predictions (e.g., a functionality), which may lead to the UE 215 activating or deactivating an AI/ML model used for beam predictions. In such examples, the network entity 205 may achieve activation or deactivation of an AI/ML model at the UE 215, and the UE 215 may reduce a likelihood of sensitive information being disclosed to the network entity 205. In some examples, however, the UE 215 and network entity 205 may lack an agreement (e.g., convergence) regarding how one or more functionalities may be defined. That is, aspects of a functionality (e.g., how functionalities are defined) may be unclear to the UE 215 or the network entity 205, or both. As such, an indication of a functionality (e.g., an instruction to validate, invalidate, or switch a functionality) from the network entity 205 may be ambiguous to the UE 215 and degrade a performance of LCM at the UE 215.

In some examples, one or more techniques for indication of a training data set for LCM, as described herein, may provide a framework to achieve AI/ML model activation or deactivation or functionality validation or invalidation. For example, use of an AI/ML model may be associated with a data set used to train an AI/ML model (e.g., a training data set). That is, AI/ML models and functionality of the AI/ML models may be associated with data sets used to train the AI/ML models. As such, the network entity 205 may use characteristics of a data set used to train an AI/ML model (e.g., a training data set) to instruct the UE 215 to activate, deactivate, or switch the AI/ML model or to validate, invalidate, or switch a functionality of the AI/ML model (e.g., a functionality that the AI/ML model may be applicable to). In other words, one or more techniques for indication of a training data set for LCM, as described herein, may enable a framework for indication of training data set for functionality-based or model-based LCM in AI/ML operations.

In some examples, indicating characteristics associated with training dataset may achieve (e.g., implicitly achieve) AI/ML model activation, deactivation, or switching, or functionality validation, invalidation, or switching. For example, the network entity 205 may indicate a characteristic of a first data set to the UE 215. In such an example, the UE 215 may use the indicated characteristic to identify an AI/ML model trained using a second data set. The second data set may be a same data set as the first data set. Alternatively, the second data set be different from the first data set. For example, the second data set may include the indicated characteristic or another characteristic that may be relatively similar to the indicated characteristic. In other words, the network entity 205 may signal characteristics (e.g., details) for training dataset that may identify one or more AI/ML models for LCM. For example, the UE 215 may select the identified AI/ML model (e.g., the AI/ML model trained using the second data set) for activation, deactivation, or switching. In some examples, the network entity 205 may signal characteristics (e.g., details) for training dataset that may identify one or more AI/ML models for one or more functionalities. For example, the network entity 205 may signal characteristics for training dataset that may identify one or more AI/ML models for beam predictions. In some examples, by indicating characteristics of training data sets, the UE 215 may reduce a likelihood of sensitive information (e.g., UE proprietary information, such as for model-based LCM) being disclosed to the network entity 205 and reduce ambiguity associated with indications from the network entity 205 (e.g., provide a clearer definition than may be available for functionality).

The UE 215 and the network entity 205 may support training dataset identified AI/ML model LCM. As illustrated in the example of FIG. 2, the UE 215 may support one or more AI/ML models (e.g., a model 235-a, a model 235-b), which may be associated with one or more functionalities (e.g., a functionality 240-a, a functionality 240-b). For example, the UE 215 may use the model 235-a for the functionality 240-a or the model 235-a may be otherwise associated with the functionality 240-a. Additionally, the UE 215 may use the model 235-b for the functionality 240-b or the model 235-b may be otherwise associated with the functionality 240-b. In some examples, the UE 215 may receive control information 225 (e.g., a network indication) regarding characteristics of a data set (e.g., a particular training dataset). That is, the control information 225 may be indicative of a characteristic 245 of a data set used for training AI/ML models at the UE 215. In some examples, the AI/ML models may be associated with one or more functionalities, such as functionalities associated with maintaining the communication link 220 (e.g., a wireless communication link). In some examples, the control information 225 (e.g., the network indication) may be carried via RRC, MAC-CE, or downlink control information (DCI). In some other examples, the control information 225 may be carried via one or more other upper layer protocols, such as via application layer signaling. In other words, the UE 215 may receive RRC layer signaling, PHY layer signaling, MAC layer signaling, or application layer signaling that includes the control information 225.

In some examples, the characteristic 245 (e.g., a general characteristic) may be associated with (e.g., satisfied by, included in) one or more data sets. For example, the characteristic 245 may be associated with multiple types of data sets. In other words, the characteristic 245 may be an example of a characteristic associated with two or more datasets, such as a data set used to train the model 235-a and a data set used to train model 235-b. In some other examples, the characteristic 245 may be associated with a single data set. For example, multiple (e.g., different) datasets may be associated with multiple (e.g., different) characteristics. In some examples, the characteristic 245 may include a scenario in which the UE 315 or the network entity 305, or both may operate, which may also be referred to as an operation scenario or a deployment scenario. For example, the characteristic 245 may include a dense urban operation scenario, an indoor operation scenario, or a rural operation scenario.

In some examples, the characteristic 245 may include a characteristic of a profile of a wireless communication link (e.g., a profile characteristic of a wireless communication link). For example, the characteristic 245 may include a range of a delay spread or a doppler spread associated with a wireless communication link (e.g., or a wireless communication channel). In some examples, the characteristic 245 may include one or more parameters associated with the network entity 305 or a cell, such as a cell served by the network entity 305. For example, the characteristic 245 may include one or more characteristics of a cell providing the coverage area 210, which may serve wireless communications between the network entity 205 and the UE 215 (e.g., may serve the communication link 220). In some examples, the characteristic 245 may include a transmit parameter used for downlink communications, such as a size, a type, or an orientation of one or more antenna arrays at the network entity 205 (e.g., a gNB), a quantity of beams in a codebook (e.g., a codebook configured for downlink communications at the network entity 205), a transmit power at the network entity 205 (e.g., a gNB transmit power), or one or more capabilities of the network entity 205. In some examples, the characteristic 245 may include a transmit parameter used for uplink communications, such as a size, a type, or an orientation of one or more antenna arrays at the UE 215, a quantity of beams in a codebook (e.g., a codebook configured for downlink communications at the UE 215, a transmit power at the UE 215 (e.g., a UE transmit power), or one or more capabilities of the UE 215. In some examples, the characteristic 245 may include a location of the UE 215 relative to the network entity 205 (e.g., whether the UE 215 is relatively close or relatively far from the network entity 205).

In some examples, the characteristic 245 may include a characteristic associated with one or more datasets for beam prediction AI/ML models. That is, the data set may be used for training beam prediction AI/ML models. In some examples, the characteristic may be associated with multiple beam prediction AI/ML models. In other words, characteristics (e.g., including the characteristic) for beam prediction AI/ML models may be included in (e.g., common to) two or more data sets. In some instances, multiple (e.g., different) data sets used for beam prediction models may be associated with multiple (e.g., different) characteristics. In some examples, the characteristic 245 may include a distribution (e.g., a maximum, a minimum, a mean, a variance, a standards deviation, a probability distribution function, a cumulative distribution function) of measured or reported (or both) received power measurements. For example, the characteristic 245 may include a distribution of LI RSRP measurements or LI SINR measurements to be used as AI/ML model inputs or AI/ML model prediction targets. In other words, the characteristic 245 may include a statistic associated with received power measurements used as input for the AI/ML models or a statistic associated with received power measurements used as a prediction target for the AI/ML models. In some examples, the characteristic 245 may include a reliability or an accuracy of the received power measurements to be used as AI/ML model inputs or AI/ML model prediction targets. That is, the characteristic 245 may include a performance metric associated with the received power measurements used as the input for the AI/ML models or a performance metric associated with the received power measurements used as the prediction target for the AI/ML models.

In some examples, the characteristic 245 may include a UE mobility characteristic, such as a direction in which the UE 215 may be moving (e.g., a moving direction), a speed at which the UE 215 may be moving (e.g., a moving speed), a direction in which the UE 215 may be rotating (e.g., a rotation direction), a speed at which the UE 215 may be rotating (e.g., a rotation speed), or an orientation of the UE 215. In some examples, the characteristic 245 may include a characteristic of a transmit beam at the network entity 205. For example, the characteristic 245 may include a transmission beam shape (e.g., a range of beam pointing directions or beam-widths of measurement resources or prediction targets). In some examples, the characteristic 245 may include a characteristic of a receive beam at the UE 215. For example, the characteristic 245 may include a receive beam shape (e.g., a range of beam pointing directions or beamwidths to measure the received power, such as the L1-RSRP or the L1-SINR.

In some examples, such as in response to receiving the control information 225, the UE 215 may determine to activate or deactivate the model 235-a (e.g., for maintaining the communication link 220). For example, the UE 215 may apply AI/ML model activation, deactivation, or switching to the model 235-a in association with the indicated characteristics of the training dataset (e.g., the control information 225). In other words, the UE 215 activate or deactivate the model 235-a in association with the characteristic 245 (e.g., a characteristic of the data set). In some other examples, the UE 215 may determine to validate or invalidate a functionality (e.g., beam prediction) of the model or another model (e.g., an activated or switched model). For example, the model 235-b may be activated and the UE 215 may determine to validate or invalidate the functionality 240-b of the model 235-b (e.g., for maintaining the communication link 220). That is, the UE 215 may apply AI/ML functionality validation, invalidation, or switching to the functionality 240-b in association with the indicated characteristics of the training dataset (e.g., the control information 225). In other words, the UE 215 activate or deactivate the functionality 240-b in association with the characteristic 245 (e.g., a characteristic of the data set).

In some examples, the UE 215 may transmit feedback information 230 to the network entity 205 based on the determining (e.g., based on determining to activate or deactivate the model 235-a or determining to validate or invalidate the functionality 240-b of the model 235-b). The feedback information 230 may be indicative of one or more parameters of the model 235-a or the functionality 240-b. For example, the UE 215 may transmit feedback information 230 to the network entity 205 based on determining to activate or deactivate the model 235-a. In such an example, the feedback information 230 may indicate one or more parameters (e.g., characteristics) associated with the model 235-a (e.g., the model that the UE 215 selected for activation, deactivation, or switching). In some examples, the feedback information 230 may indicate a correspondence (e.g., a level of similarity) between the characteristic 245 (e.g., the UE identified data characteristic) and the one or more parameters of the model 235-a (e.g., the model the UE 215 selected). Additionally, or alternatively, the UE 215 may transmit feedback information 230 to the network entity 205 based on determining to validate or invalidate the functionality 240-b. In such an example, the feedback information 230 may indicate one or more parameters (e.g., characteristics) associated with the functionality 240-b (e.g., the functionality that the UE 215 selected for an activated or switched model, the functionality that the UE 215 selected to validate, invalidate, or switch). In some examples, the feedback information 230 may indicate a correspondence (e.g., a level of similarity) between the characteristic 245 (e.g., the UE identified data characteristic) and the one or more parameters of the functionality 240-b (e.g., the functionality the UE 215 selected). In some examples, by indicating the feedback information 230 to the network entity 205, the UE 215 may improve LCM of AI/ML models, among other benefits.

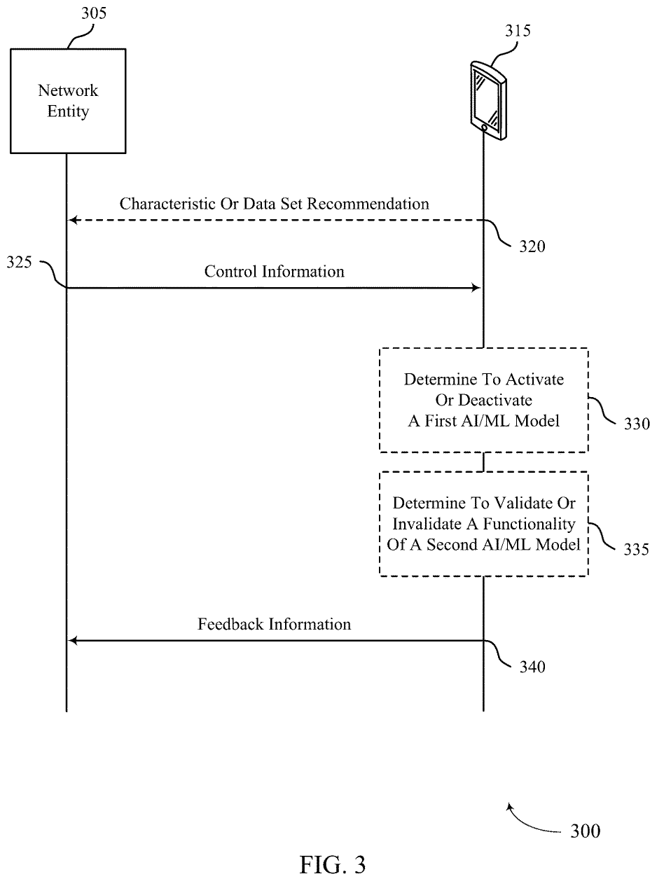

FIG. 3 shows an example of a process flow 300 that supports indication of a training data set for LCM in accordance with one or more aspects of the present disclosure. In some examples, the process flow 300 may implement one or more aspects of wireless communications system 100 and the wireless communications system 200. For example, the process flow 300 may include example operations associated a network entity 305 and a UE 315, which may be examples of the corresponding devices illustrated by and described with reference to FIGS. 1 and 2. The operations performed by the network entity 305 and the UE 315 may support improvements to communications between the UE 315 and the network entity 305, among other benefits. In the following description of the process flow 300, the operations between the UE 315 and the network entity 305 may occur in a different order than the example order shown. Additionally, or alternatively, the operations performed by the UE 315 and the network entity 305 may be performed in different orders or at different times. Some operations may also be omitted or combined. The UE 315 and the network entity 305 may support a framework for indicating characteristics associated with training data set to achieve ML model (e.g., AI/ML model) activation or deactivation or functionality validation or invalidation.

At 325, the UE 315 may receive control information from the network entity 305. The control information may be an example of control information illustrated by and described with reference to FIGS. 1 and 2. For example, the control information may be indicative of a characteristic of a data set used for training ML models (e.g., AI/ML models) at the UE 315. The characteristic may be an example of a characteristic illustrated by and described with reference to FIGS. 1 and 2. For example, the characteristic may be associated with data sets used to train AI/ML models, such as multiple types of AI/ML models (e.g., to train AI/ML models used for multiple types of functionalities) or AI/ML models for one or more functionalities. For example, the characteristic may be associated with data sets used to train AI/ML models for beam predictions. The AI/ML models may be examples of AI/ML models illustrated by and described with reference to FIGS. 1 and 2. For example, the AI/ML models may be associated with maintaining a wireless communication link.

The network entity 305 may support one or more techniques (e.g., methods) for indicating data sets (e.g., reference data sets, training data sets) to the UE 315. For example, the UE 315 or the network entity 305, or both, may be configured with multiple data sets used for training AI/ML models at the UE 315 (e.g., reference data sets, training data sets). The multiple data sets (e.g., each of the multiple data sets) may be associated with one or more characteristics. Additionally, the multiple data sets may be associated with (e.g., defied be, defined with) multiple data set IDs. That is, each data set may be associated with a respective data set ID and a respective one or more characteristics. In such an example, the network entity 305 may indicate, to the UE 315, a data set ID associated with the data set. In other words, the network entity 305 may transmit an indication that includes one or more data set IDs corresponding to (e.g., identifying) one or more data sets. That is, the network entity 305 may indicate (e.g., directly indicate, explicitly indicate) a characteristic of a data set via the data set ID of the data set. In other words, the control information received at the UE 315 (e.g., at 325) may include a data set ID corresponding to the data set, which may be associated with (e.g., include, satisfy) the characteristic.

In some other examples, the UE 315 or the network entity 305, or both, may be configured with multiple characteristics (e.g., data set characteristics). The multiple characteristics may be associated with (e.g., defined by, defied with) multiple characteristic IDs. That is, each characteristic may be associated with a respective characteristic ID. In other words, the UE 315 or the network entity 305 may be configured with one or more characteristics (e.g., characteristic options) of training data sets (e.g., reference training data sets) that may be associated with characteristic IDs (e.g., characteristic option IDs). In such an example, the network entity 305 may indicate, to the UE 315, a characteristic ID associated with the characteristic. In other words, the network entity 305 may transmit an indication that includes one or more characteristic IDs (e.g., one or more characteristic options) and, in some examples, values associated with the corresponding characteristics (e.g., the corresponding characteristic values). That is, the network entity 305 may indicate (e.g., directly indicates, explicitly indicates) the characteristic via an indication of the corresponding characteristic ID. In other words, the control information received at the UE 315 (e.g., at 325) may include a characteristic ID corresponding to the characteristic of the data set. In some examples, the UE 315 may identify one or more AI/ML models trained using a data set that includes (or is otherwise associated with) the characteristic corresponding to the indicated characteristic ID. In some examples, an identified AI/ML model may be deactivated at the UE 315. In such an example, the UE 315 may determine to activate the identified AI/ML model.

In some examples, the network entity 305 may configure (e.g., RRC configure) the UE 315 with a subset of IDs that may include one or more data set IDs or one or more characteristic IDs, or any combination thereof. For example, the network entity 305 may configure a subset that includes one or more data sets (e.g., and one or more corresponding characteristics), or one or more characteristics of one or more data set, or any combination thereof. In some examples, the network entity 305 may configure the subset via a subset of IDs that includes one or more data set IDs (e.g., corresponding to the one or more data sets), or one or more characteristic IDs (e.g., corresponding to the one or more characteristics), or any combination thereof. In some examples, the network entity 305 may configure the subset (e.g., indicate the subset of IDs) via RRC signaling or via one or more other upper layer protocols. In such examples, the network entity 305 may indicate, to the UE 315, a characteristic ID or a data set ID associated with the configured subset. In other words, the network entity 305 may transmit an indication that includes one or more characteristic IDs (e.g., one or more characteristic options) or one or more data set IDs included in the configured subset. That is, the control information received at the UE 315 (e.g., at 325) may include a characteristic ID corresponding to the characteristic, or a data set ID corresponding to the data set, or both, and the characteristic ID or the data set ID, or both, may be included in the configured subset.

In some examples, at 320, the UE 315 may transmit a characteristic or data set recommendation to the network entity 305. For example, the UE 315 may transmit, to the network entity 305, an uplink message that includes one or more data set IDs corresponding to one or more recommended data sets, one or more characteristic IDs corresponding to one or more recommended characteristics, or both. In such an example, the control information (e.g., received at the UE at 325) may be based on the characteristic or data set recommendation (e.g., the uplink message). In other words, the UE 315 may recommend (or request) one or more data set IDs or one or more characteristic IDs, or any combination thereof, to the network entity 305. For example, the UE 315 may report, to the network entity 305, a subset of one or more recommended data sets (e.g., and the corresponding characteristics, such as via data set IDs), or one or more recommended characteristics (e.g., via corresponding characteristic IDs), or both.

In some examples, the UE 315 may expect to receive control information (e.g., a network indication) associated with the recommended subset (e.g., options that the UE 315 recommended). In such examples, the network entity 305 may indicate, to the UE 315, a characteristic ID or a data set ID associated with the recommended subset. In other words, the network entity 305 may transmit an indication that includes one or more characteristic IDs (e.g., one or more characteristic options) or one or more data set IDs included in the recommended subset. That is, the control information received at the UE 315 (e.g., at 325) may include a characteristic ID corresponding to the characteristic, or a data set ID corresponding to the data set, or both, and the characteristic ID or the data set ID, or both, may be included in the recommended subset.

In some examples, at 330, the UE 315 may determine to activate or deactivate a first AI/ML model for maintaining the wireless communication link based on receiving the control information. For example, the UE 315 may activate or deactivate the first AI/ML model in association with the characteristic of the data set. In some examples, the AI/ML model may be for beam predictions. That is, the data set may be used for training beam prediction AI/ML models. In such an example, the UE 315 may predict a transmit beam at the network entity 305 or a receive beam at the UE 315 (e.g., for maintaining the wireless communication link) using the first AI/ML model based on activating the first AI/ML model.

In some examples, the UE 315 may use the first AI/ML model to make predictions (e.g., to predict a transmit beam at the network entity 305 or a receive beam at the UE 315) in accordance with a first time increment (e.g., 200 ms). In some examples, the control information may indicate a data set ID of a data set used to train another AI/ML model used for making predictions in accordance with a second time increment (e.g., 20 ms). In such an example, the UE 315 may determine to deactivate the first AI/ML model and activate another AI/ML model that may be used for making predictions in accordance with the second time increment (e.g., 20 ms) or a third time increment that may be relatively similar to the second time increment (e.g., the third time increment may have a value closer to 20 than 200). In some other examples, the UE 315 may determine to modify (e.g., switch, change) the first AI/ML model, such that the first AI/ML model may be used for making predictions in accordance with the second time increment (e.g., 20 ms) or the third time increment that may be relatively similar to the second time increment.

Additionally, or alternatively, at 335, the UE 315 may determine to validate or invalidate a functionality of a second AI/ML model for maintaining the wireless communication link based on receiving the control information. For example, the UE 315 may validate or invalidate the functionality of the second AI/ML model in association with the characteristic of the data set. In some examples, the second AI/ML model may be for beam predictions. That is, the data set may be used for training beam prediction AI/ML models. In such examples, the UE 315 may predict a transmit beam at the network entity 305 or a receive beam at the UE 315 (e.g., for maintaining the wireless communication link) using the second AI/ML model based on validating the functionality of the second AI/ML model.

In some examples, the UE 315 may use the second AI/ML model to make predictions (e.g., to predict a transmit beam at the network entity 305 or a receive beam at the UE 315). In some examples, the control information may indicate a characteristic ID corresponding to a UE mobility characteristic, such as a direction in which the UE 315 may be moving (e.g., a moving direction), a speed at which the UE 315 may be moving (e.g., a moving speed), a direction in which the UE 315 may be rotating (e.g., a rotation direction), a speed at which the UE 315 may be rotating (e.g., a rotation speed), or an orientation of the UE 315. In such examples, the UE 315 may determine to validate (or invalidate) beam predictions at the UE 315 using the second AI/ML model. For example, the UE 315 may validate (or invalidate) beam predictions at the UE 315 using the second AI/ML model to determine whether the second AI/ML model produce predictions or outputs with suitable fidelity to be used (e.g., relatively reliably) to achieve beam predictions based on the UE mobility characteristic (e.g., based on a direction or speed that the UE 315 may be moving or rotating). In some examples, based on the validation, the UE 315 may determine to activate, deactivate, or modify the second AI/ML model. For example, the UE 315 may determine that predictions or outputs of the second AI/ML model fail to satisfy a threshold fidelity (e.g., that may be based on the UE mobility characteristic). In such an example, the UE 315 may determine to modify the second AI/ML model, such that predictions or outputs of the second AI/ML model satisfy the threshold fidelity. Alternatively, the UE 315 may determine to deactivate the second AI/ML model and activate another AI/ML model in which the predictions or outputs satisfy the threshold fidelity.

At 340, the UE 315 may transmit feedback information to the network entity 305 based on determining to activate or deactivate the first AI/ML model (e.g., at 330) or based on determining to validate or invalidate the functionality of the second AI/ML model (e.g., at 335). The feedback information may be an example of feedback information illustrated by and described with reference to FIGS. 1 and 2. For example, the feedback information may be indicative of one or more parameters of the first AI/ML model or the functionality of the second AI/ML model. In some examples, the UE 315 may identify the one or more parameters of the first AI/ML model or the functionality of the second AI/ML model in response to the determining. The one or more parameters may be based on correspondence between the one or more parameters and the characteristic. In some examples, the feedback information may indicate (e.g., confirm) activation or deactivation of the first AI/ML model at the UE 315 or validation or invalidation of the functionality of the second AI/ML model at the UE 315. In some examples, by indicating the characteristic to the UE 315 (e.g., via the control information), the network entity 305 may improve LCM of AI/ML models at the UE 315, among other benefits.

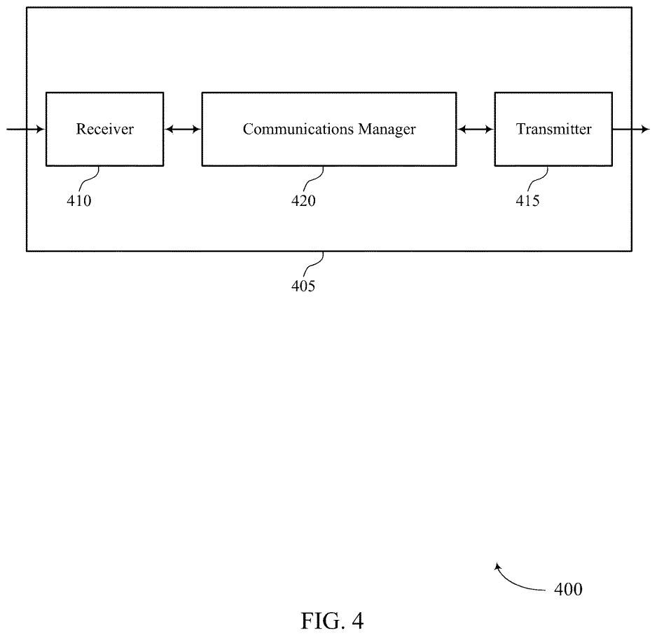

FIG. 4 shows a block diagram 400 of a device 405 that supports indication of a training data set for LCM in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to indication of a training data set for LCM). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to indication of a training data set for LCM). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of indication of a training data set for LCM as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE (e.g., the device 405) in accordance with examples as disclosed herein. For example, the communications manager 420 is capable of, configured to, or operable to support a means for receiving, from a network entity, control information indicative of a characteristic of a data set used for training ML models at the UE, the ML models associated with maintaining a wireless communication link. The communications manager 420 is capable of, configured to, or operable to support a means for determining to activate or deactivate a first ML model for maintaining the wireless communication link or validate or invalidate a functionality of a second ML model for maintaining the wireless communication link based on receiving the control information. The communications manager 420 is capable of, configured to, or operable to support a means for transmitting, to the network entity, feedback information indicative of one or more parameters of the first ML model or the functionality of the second ML model based on the determining.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for reduced processing.

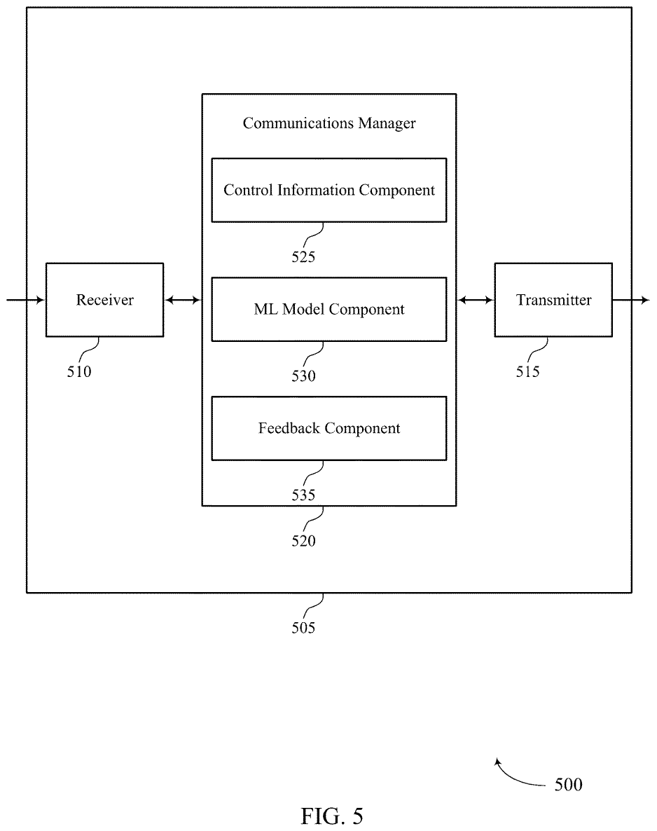

FIG. 5 shows a block diagram 500 of a device 505 that supports indication of a training data set for LCM in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to indication of a training data set for LCM). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to indication of a training data set for LCM). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of indication of a training data set for LCM as described herein. For example, the communications manager 520 may include a control information component 525, an ML model component 530, a feedback component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE (e.g., the device 505) in accordance with examples as disclosed herein. The control information component 525 is capable of, configured to, or operable to support a means for receiving, from a network entity, control information indicative of a characteristic of a data set used for training ML models at the UE, the ML models associated with maintaining a wireless communication link. The ML model component 530 is capable of, configured to, or operable to support a means for determining to activate or deactivate a first ML model for maintaining the wireless communication link or validate or invalidate a functionality of a second ML model for maintaining the wireless communication link based on receiving the control information. The feedback component 535 is capable of, configured to, or operable to support a means for transmit, to the network entity, feedback information indicative of one or more parameters of the first ML model or the functionality of the second ML model based on the determining.

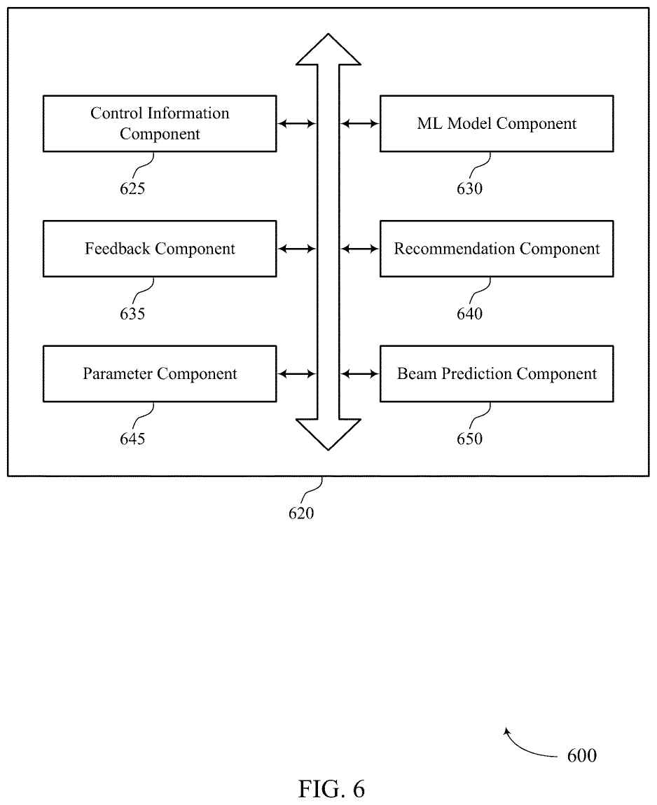

FIG. 6 shows a block diagram 600 of a communications manager 620 that supports indication of a training data set for LCM in accordance with one or more aspects of the present disclosure. The communications manager 620 may be an example of aspects of a communications manager 420, a communications manager 520, or both, as described herein. The communications manager 620, or various components thereof, may be an example of means for performing various aspects of indication of a training data set for LCM as described herein. For example, the communications manager 620 may include a control information component 625, an ML model component 630, a feedback component 635, a recommendation component 640, a parameter component 645, a beam prediction component 650, or any combination thereof. Each of these components may communicate, directly or indirectly, with one another (e.g., via one or more buses).

The communications manager 620 may support wireless communications at a UE in accordance with examples as disclosed herein. The control information component 625 is capable of, configured to, or operable to support a means for receiving, from a network entity, control information indicative of a characteristic of a data set used for training ML models at the UE, the ML models associated with maintaining a wireless communication link. The ML model component 630 is capable of, configured to, or operable to support a means for determining to activate or deactivate a first ML model for maintaining the wireless communication link or validate or invalidate a functionality of a second ML model for maintaining the wireless communication link based on receiving the control information. The feedback component 635 is capable of, configured to, or operable to support a means for transmit, to the network entity, feedback information indicative of one or more parameters of the first ML model or the functionality of the second ML model based on the determining.

In some examples, to support receiving the control information, the control information component 625 is capable of, configured to, or operable to support a means for receiving a data set ID corresponding to the data set or a characteristic ID corresponding to the characteristic, or both.

In some examples, the recommendation component 640 is capable of, configured to, or operable to support a means for transmitting, to the network entity, an uplink message including one or more data set IDs corresponding to one or more recommended data sets, one or more characteristic IDs corresponding to one or more recommended characteristics, or both, where the control information is based on the uplink message. In some examples, the one or more data set IDs includes at least the data set ID. In some examples, the one or more characteristic IDs includes at least the characteristic ID.

In some examples, the characteristic includes an operation scenario for the wireless communication link, a profile characteristic of the wireless communication link, a parameter of a cell serving the wireless communication link, a transmit parameter used for downlink communications via the wireless communication link, a transmit parameter used for uplink communications via the wireless communication link, or a distance between the network entity and the UE. In some examples, the first ML model and the second ML model each include a respective beam prediction ML model based on the data set being used for training beam prediction ML models.

In some examples, the characteristic includes a statistic associated with received power measurements used as input for the ML models, a statistic associated with received power measurements used as a prediction target for the ML models, a performance metric associated with the received power measurements used as the input for the ML models, a performance metric associated with the received power measurements used as the prediction target for the ML models, a UE mobility characteristic, a characteristic of a transmit beam at the network entity, or a characteristic of a receive beam at the UE.

In some examples, to support receiving the control information, the control information component 625 is capable of, configured to, or operable to support a means for receiving RRC layer signaling, PHY layer signaling, MAC layer signaling, or application layer signaling that includes the control information. In some examples, to support transmitting the feedback information, the feedback component 635 is capable of, configured to, or operable to support a means for transmitting an indication of a correspondence between the one or more parameters and the characteristic.

In some examples, the parameter component 645 is capable of, configured to, or operable to support a means for identifying the one or more parameters in response to the determining and based on the correspondence between the one or more parameters and the characteristic, where the feedback information indicates activation or deactivation of the first ML model at the UE or validation or invalidation of the functionality of the second ML model at the UE. In some examples, to support transmitting the feedback information, the feedback component 635 is capable of, configured to, or operable to support a means for transmitting an indication of the one or more parameters.

In some examples, the ML model component 630 is capable of, configured to, or operable to support a means for activating or deactivating the first ML model in association with the characteristic of the data set. In some examples, the beam prediction component 650 is capable of, configured to, or operable to support a means for predicting a transmit beam at the network entity or a receive beam at the UE for maintaining the wireless communication link using the first ML model based on activating the first ML model, where the data set is used for training beam prediction ML models.

In some examples, the ML model component 630 is capable of, configured to, or operable to support a means for validating or invalidating the functionality of the second ML model in association with the characteristic of the data set. In some examples, the beam prediction component 650 is capable of, configured to, or operable to support a means for predicting a transmit beam at the network entity or a receive beam at the UE for maintaining the wireless communication link using the second ML model based on validating the functionality of the second ML model, where the data set is used for training beam prediction ML models.

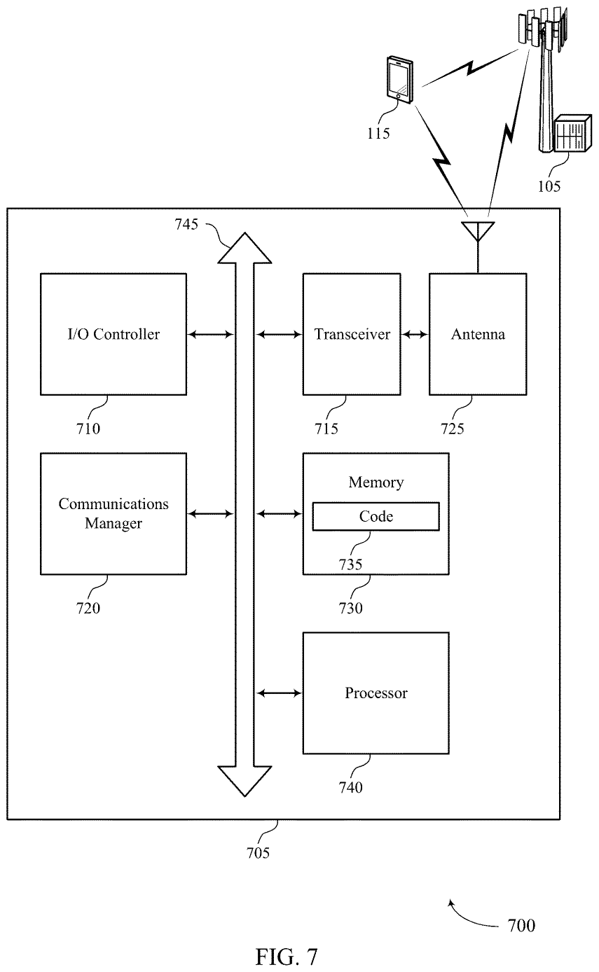

FIG. 7 shows a diagram of a system 700 including a device 705 that supports indication of a training data set for LCM in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting indication of a training data set for LCM). For example, the device 705 or a component of the device 705 may include a processor 740 and memory 730 coupled with or to the processor 740, the processor 740 and memory 730 configured to perform various functions described herein.

The communications manager 720 may support wireless communications at a UE (e.g., the device 705) in accordance with examples as disclosed herein. For example, the communications manager 720 is capable of, configured to, or operable to support a means for receiving, from a network entity, control information indicative of a characteristic of a data set used for training ML models at the UE, the ML models associated with maintaining a wireless communication link. The communications manager 720 is capable of, configured to, or operable to support a means for determining to activate or deactivate a first ML model for maintaining the wireless communication link or validate or invalidate a functionality of a second ML model for maintaining the wireless communication link based on receiving the control information. The communications manager 720 is capable of, configured to, or operable to support a means for transmitting, to the network entity, feedback information indicative of one or more parameters of the first ML model or the functionality of the second ML model based on the determining.

By including or configuring the communications manager 720 in accordance with examples as described herein, the device 705 may support techniques for improved communication reliability, reduced latency, improved user experience related to reduced processing, and improved utilization of processing capability.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of indication of a training data set for LCM as described herein, or the processor 740 and the memory 730 may be otherwise configured to perform or support such operations.

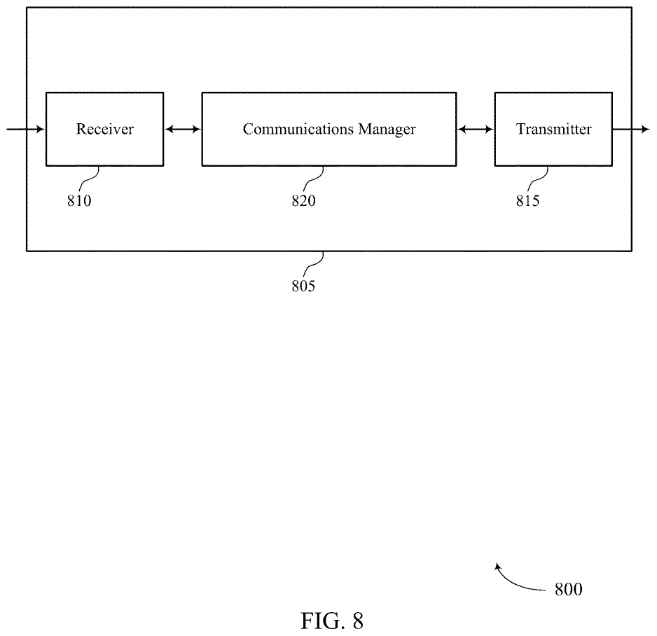

FIG. 8 shows a block diagram 800 of a device 805 that supports indication of a training data set for LCM in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of indication of a training data set for LCM as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity (e.g., the device 805) in accordance with examples as disclosed herein. For example, the communications manager 820 is capable of, configured to, or operable to support a means for outputting control information indicative of a characteristic of a data set used for training ML models at a UE, the ML models associated with maintaining a wireless communication link. The communications manager 820 is capable of, configured to, or operable to support a means for obtaining, in response to the control information, feedback information indicative of one or more parameters of a first ML model or a functionality of a second ML model based on a determination to activate or deactivate the first ML model for maintaining the wireless communication link or validate or invalidate a functionality of the second ML model for maintaining the wireless communication link.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing.

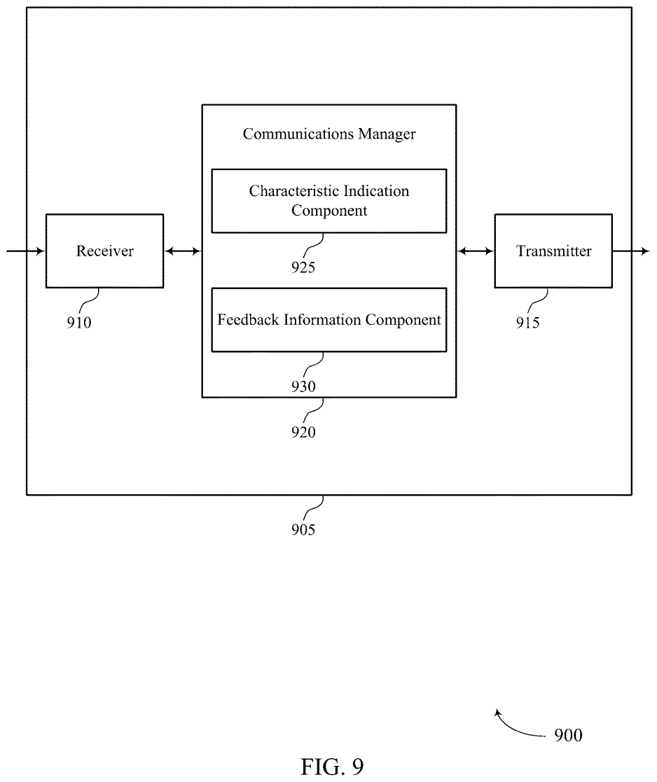

FIG. 9 shows a block diagram 900 of a device 905 that supports indication of a training data set for LCM in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of indication of a training data set for LCM as described herein. For example, the communications manager 920 may include a characteristic indication component 925 a feedback information component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity (e.g., the device 905) in accordance with examples as disclosed herein. The characteristic indication component 925 is capable of, configured to, or operable to support a means for outputting control information indicative of a characteristic of a data set used for training ML models at a UE, the ML models associated with maintaining a wireless communication link. The feedback information component 930 is capable of, configured to, or operable to support a means for obtaining, in response to the control information, feedback information indicative of one or more parameters of a first ML model or a functionality of a second ML model based on a determination to activate or deactivate the first ML model for maintaining the wireless communication link or validate or invalidate a functionality of the second ML model for maintaining the wireless communication link.

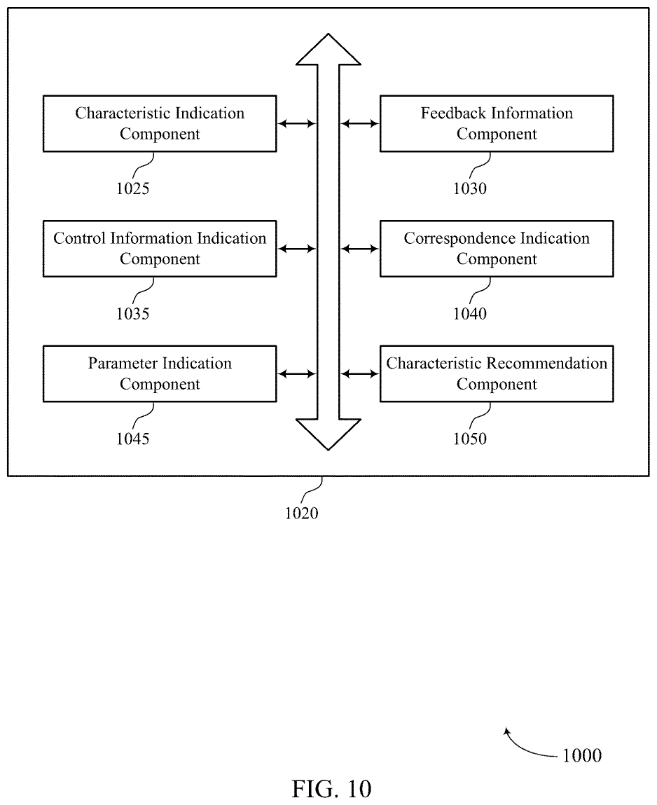

FIG. 10 shows a block diagram 1000 of a communications manager 1020 that supports indication of a training data set for LCM in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of indication of a training data set for LCM as described herein. For example, the communications manager 1020 may include a characteristic indication component 1025, a feedback information component 1030, a control information indication component 1035, a correspondence indication component 1040, a parameter indication component 1045, a characteristic recommendation component 1050, or any combination thereof.

Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The characteristic indication component 1025 is capable of, configured to, or operable to support a means for outputting control information indicative of a characteristic of a data set used for training ML models at a UE, the ML models associated with maintaining a wireless communication link. The feedback information component 1030 is capable of, configured to, or operable to support a means for obtaining, in response to the control information, feedback information indicative of one or more parameters of a first ML model or a functionality of a second ML model based on a determination to activate or deactivate the first ML model for maintaining the wireless communication link or validate or invalidate a functionality of the second ML model for maintaining the wireless communication link.

In some examples, to support outputting the control information, the characteristic indication component 1025 is capable of, configured to, or operable to support a means for outputting a data set ID corresponding to the data set or a characteristic ID corresponding to the characteristic, or both.

In some examples, the characteristic recommendation component 1050 is capable of, configured to, or operable to support a means for obtaining an uplink message including one or more data set IDs corresponding to one or more recommended data sets, one or more characteristic IDs corresponding to one or more recommended characteristics, or both, where the control information is based on the uplink message. In some examples, the one or more data set IDs includes at least the data set ID. In some examples, the one or more characteristic IDs includes at least the characteristic ID.

In some examples, the characteristic includes an operation scenario for the wireless communication link, a profile characteristic of the wireless communication link, a parameter of a cell serving the wireless communication link, a transmit parameter used for downlink communications via the wireless communication link, a transmit parameter used for uplink communications via the wireless communication link, or a distance between the network entity and the UE.

In some examples, the first ML model and the second ML model each include a respective beam prediction ML model based on the data set being used for training beam prediction ML models. In some examples, the characteristic includes a statistic associated with received power measurements used as input for the ML models, a statistic associated with received power measurements used as a prediction target for the ML models, a performance metric associated with the received power measurements used as the input for the ML models, a performance metric associated with the received power measurements used as the prediction target for the ML models, a UE mobility characteristic, a characteristic of a transmit beam at the network entity, or a characteristic of a receive beam at the UE.

In some examples, to support outputting the control information, the control information indication component 1035 is capable of, configured to, or operable to support a means for outputting RRC layer signaling, PHY layer signaling, MAC layer signaling, or application layer signaling that includes the control information.

In some examples, to support obtaining the feedback information, the correspondence indication component 1040 is capable of, configured to, or operable to support a means for obtaining an indication of a correspondence between the one or more parameters and the characteristic.

In some examples, to support obtaining the feedback information, the parameter indication component 1045 is capable of, configured to, or operable to support a means for obtaining an indication of the one or more parameters.

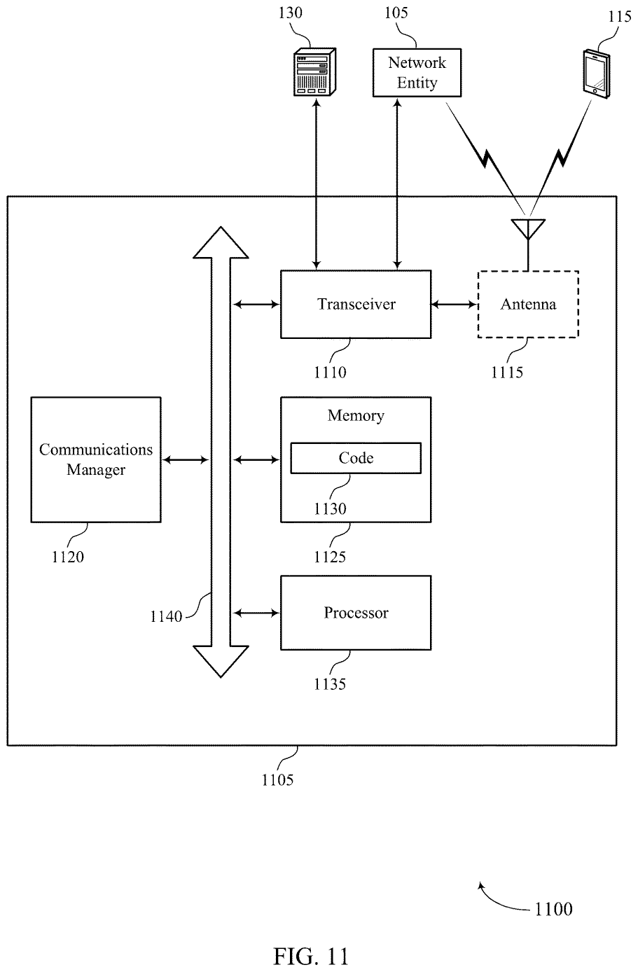

FIG. 11 shows a diagram of a system 1100 including a device 1105 that supports indication of a training data set for LCM in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting indication of a training data set for LCM). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity (e.g., the device 1105) in accordance with examples as disclosed herein. For example, the communications manager 1120 is capable of, configured to, or operable to support a means for outputting control information indicative of a characteristic of a data set used for training ML models at a UE, the ML models associated with maintaining a wireless communication link. The communications manager 1120 is capable of, configured to, or operable to support a means for obtaining, in response to the control information, feedback information indicative of one or more parameters of a first ML model or a functionality of a second ML model based on a determination to activate or deactivate the first ML model for maintaining the wireless communication link or validate or invalidate a functionality of the second ML model for maintaining the wireless communication link.

By including or configuring the communications manager 1120 in accordance with examples as described herein, the device 1105 may support techniques for improved communication reliability, reduced latency, improved user experience related to reduced processing, and improved utilization of processing capability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of indication of a training data set for LCM as described herein, or the processor 1135 and the memory 1125 may be otherwise configured to perform or support such operations.

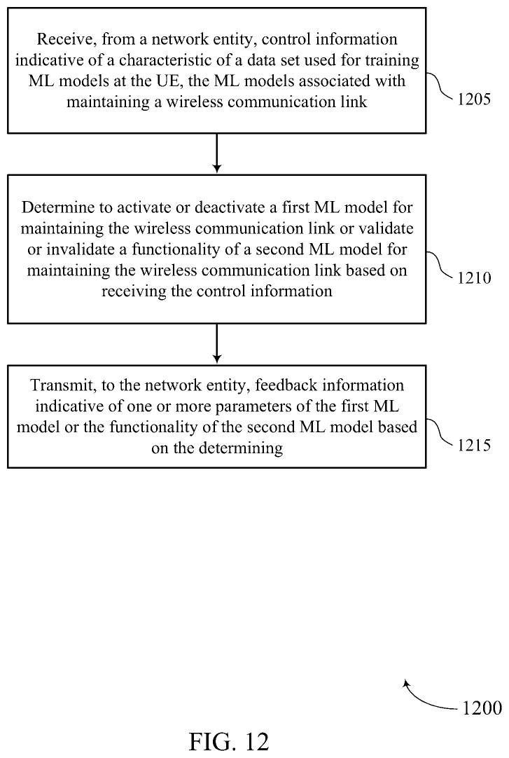

FIG. 12 shows a flowchart illustrating a method 1200 that supports indication of a training data set for LCM in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the wireless UE to perform the described functions. Additionally, or alternatively, the wireless UE may perform aspects of the described functions using special-purpose hardware.

At 1205, the method may include receiving, from a network entity, control information indicative of a characteristic of a data set used for training ML models at the UE, the ML models associated with maintaining a wireless communication link. The operations of 1205 may be performed in accordance with examples as disclosed herein. In some examples, aspects of the operations of 1205 may be performed by a control information component 625 as described with reference to FIG. 6.

At 1210, the method may include determining to activate or deactivate a first ML model for maintaining the wireless communication link or validate or invalidate a functionality of a second ML model for maintaining the wireless communication link based on receiving the control information. The operations of 1210 may be performed in accordance with examples as disclosed herein. In some examples, aspects of the operations of 1210 may be performed by an ML model component 630 as described with reference to FIG. 6.

At 1215, the method may include transmit, to the network entity, feedback information indicative of one or more parameters of the first ML model or the functionality of the second ML model based on the determining. The operations of 1215 may be performed in accordance with examples as disclosed herein. In some examples, aspects of the operations of 1215 may be performed by a feedback component 635 as described with reference to FIG. 6.

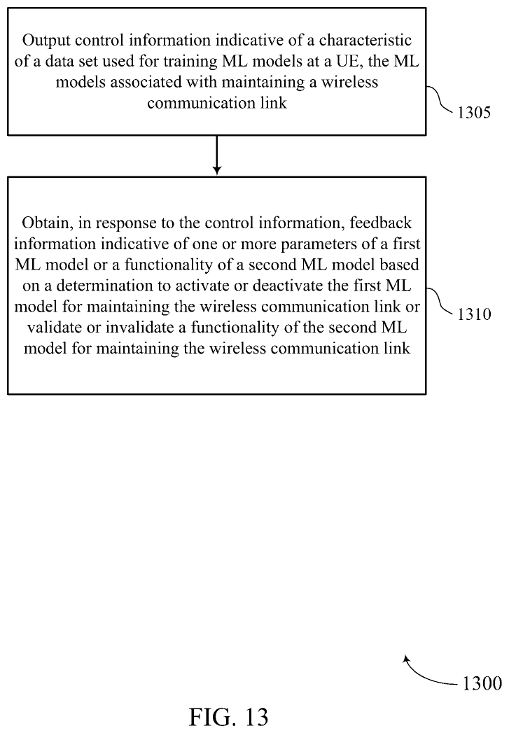

FIG. 13 shows a flowchart illustrating a method 1300 that supports indication of a training data set for LCM in accordance with aspects of the present disclosure. The operations of the method 1300 may be implemented by a network entity or its components as described herein. For example, the operations of the method 1300 may be performed by a network entity as described with reference to FIGS. 1 and 2 and 8 through 11. In some examples, a network entity may execute a set of instructions to control the functional elements of the wireless network entity to perform the described functions. Additionally, or alternatively, the wireless network entity may perform aspects of the described functions using special-purpose hardware.

At 1305, the method may include outputting control information indicative of a characteristic of a data set used for training ML models at a UE, the ML models associated with maintaining a wireless communication link. The operations of 1305 may be performed in accordance with examples as disclosed herein. In some examples, aspects of the operations of 1305 may be performed by a characteristic indication component 1025 as described with reference to FIG. 10.

At 1310, the method may include obtaining, in response to the control information, feedback information indicative of one or more parameters of a first ML model or a functionality of a second ML model based on a determination to activate or deactivate the first ML model for maintaining the wireless communication link or validate or invalidate a functionality of the second ML model for maintaining the wireless communication link. The operations of 1310 may be performed in accordance with examples as disclosed herein. In some examples, aspects of the operations of 1310 may be performed by a feedback information component 1030 as described with reference to FIG. 10.

The following provides an overview of aspects of the present disclosure:
Aspect 1: A method for wireless communications at a UE, comprising: receiving, from a network entity, control information indicative of a characteristic of a data set used for training ML models at the UE, the ML models associated with maintaining a wireless communication link; determining to activate or deactivate a first ML model for maintaining the wireless communication link or validate or invalidate a functionality of a second ML model for maintaining the wireless communication link based at least in part on receiving the control information; and transmit, to the network entity, feedback information indicative of one or more parameters of the first ML model or the functionality of the second ML model based at least in part on the determining.

Aspect 2: The method of aspect 1, wherein receiving the control information comprises: receiving a data set ID corresponding to the data set or a characteristic ID corresponding to the characteristic, or both.

Aspect 3: The method of aspect 2, further comprising: transmitting, to the network entity, an uplink message comprising one or more data set IDs corresponding to one or more recommended data sets, one or more characteristic IDs corresponding to one or more recommended characteristics, or both, wherein the control information is based at least in part on the uplink message.

Aspect 4: The method of aspect 3, wherein the one or more data set IDs comprises at least the data set ID, and the one or more characteristic IDs comprises at least the characteristic ID.

Aspect 5: The method of any of aspects 1 through 4, wherein the characteristic comprises an operation scenario for the wireless communication link, a profile characteristics of the wireless communication link, a parameter of a cell serving the wireless communication link, a transmit parameter used for downlink communications via the wireless communication link, a transmit parameter used for uplink communications via the wireless communication link, or a distance between the network entity and the UE.

Aspect 6: The method of any of aspects 1 through 4, wherein the first ML model and the second ML model each comprise a respective beam prediction ML model based at least in part on the data set being used for training beam prediction ML modes.

Aspect 7: The method of aspect 6, wherein the characteristic comprises a statistic associated with received power measurements used as input for the ML models, a statistic associated with received power measurements used as a prediction target for the ML models, a performance metric associated with the received power measurements used as the input for the ML models, a performance metric associated with the received power measurements used as the prediction target for the ML models, a UE mobility characteristic, a characteristic of a transmit beam at the network entity, or a characteristic of a receive beam at the UE.

Aspect 8: The method of any of aspects 1 through 7, wherein receiving the control information comprises: receiving RRC layer signaling, PHY layer signaling, MAC layer signaling, or application layer signaling that comprises the control information.

Aspect 9: The method of any of aspects 1 through 8, wherein transmitting the feedback information comprises: transmitting an indication of a correspondence between the one or more parameters and the characteristic.

Aspect 10: The method of aspect 9, further comprising: identifying the one or more parameters in response to the determining and based at least in part on the correspondence between the one or more parameters and the characteristic, wherein the feedback information indicates activation or deactivation of the first ML model at the UE or validation or invalidation of the functionality of the second ML model at the UE.

Aspect 11: The method of any of aspects 1 through 8, wherein transmitting the feedback information comprises: transmitting an indication of the one or more parameters.

Aspect 12: The method of any of aspects 1 through 11, further comprising: activating or deactivating the first ML model in association with the characteristic of the data set.

Aspect 13: The method of aspect 12, further comprising: predicting a transmit beam at the network entity or a receive beam at the UE for maintaining the wireless communication link using the first ML model based at least in part on activating the first ML model, wherein the data set is used for training beam prediction ML models.

Aspect 14: The method of any of aspects 1 through 11, further comprising: validating or invalidating the functionality of the second ML model in association with the characteristic of the data set.

Aspect 15: The method of aspect 14, further comprising: predicting a transmit beam at the network entity or a receive beam at the UE for maintaining the wireless communication link using the second ML model based at least in part on validating the functionality of the second ML model, wherein the data set is used for training beam prediction ML models.

Aspect 16: A method for wireless communications at a network entity, comprising: outputting control information indicative of a characteristic of a data set used for training ML models at a UE, the ML models associated with maintaining a wireless communication link; and obtaining, in response to the control information, feedback information indicative of one or more parameters of a first ML model or a functionality of a second ML model based at least in part on a determination to activate or deactivate the first ML model for maintaining the wireless communication link or validate or invalidate a functionality of the second ML model for maintaining the wireless communication link.

Aspect 17: The method of aspect 16, wherein outputting the control information comprises: outputting a data set ID corresponding to the data set or a characteristic ID corresponding to the characteristic, or both.

Aspect 18: The method of aspect 17, further comprising: obtaining an uplink message comprising one or more data set IDs corresponding to one or more recommended data sets, one or more characteristic IDs corresponding to one or more recommended characteristics, or both, wherein the control information is based at least in part on the uplink message.

Aspect 19: The method of aspect 18, wherein the one or more data set IDs comprises at least the data set ID, and the one or more characteristic IDs comprises at least the characteristic ID.

Aspect 20: The method of any of aspects 16 through 19, wherein the characteristic comprises an operation scenario for the wireless communication link, a profile characteristics of the wireless communication link, a parameter of a cell serving the wireless communication link, a transmit parameter used for downlink communications via the wireless communication link, a transmit parameter used for uplink communications via the wireless communication link, or a distance between the network entity and the UE.

Aspect 21: The method of any of aspects 16 through 19, wherein the first ML model and the second ML model each comprise a respective beam prediction ML model based at least in part on the data set being used for training beam prediction ML modes.

Aspect 22: The method of aspect 21, wherein the characteristic comprises a statistic associated with received power measurements used as input for the ML models, a statistic associated with received power measurements used as a prediction target for the ML models, a performance metric associated with the received power measurements used as the input for the ML models, a performance metric associated with the received power measurements used as the prediction target for the ML models, a UE mobility characteristic, a characteristic of a transmit beam at the network entity, or a characteristic of a receive beam at the UE.

Aspect 23: The method of any of aspects 16 through 22, wherein outputting the control information comprises: outputting RRC layer signaling, PHY layer signaling, MAC layer signaling, or application layer signaling that comprises the control information.

Aspect 24: The method of any of aspects 16 through 23, wherein obtaining the feedback information comprises: obtaining an indication of a correspondence between the one or more parameters and the characteristic.

Aspect 25: The method of any of aspects 16 through 23, wherein obtaining the feedback information comprises: obtaining an indication of the one or more parameters.

Aspect 26: An apparatus for wireless communications at a UE, comprising a processor; memory coupled with the processor; and instructions stored in the memory and executable by the processor to cause the apparatus to perform a method of any of aspects 1 through 15.

Aspect 27: An apparatus for wireless communications at a UE, comprising at least one means for performing a method of any of aspects 1 through 15.

Aspect 28: A non-transitory computer-readable medium storing code for wireless communications at a UE, the code comprising instructions executable by a processor to perform a method of any of aspects 1 through 15.

Aspect 29: An apparatus for wireless communications at a network entity, comprising a processor; memory coupled with the processor; and instructions stored in the memory and executable by the processor to cause the apparatus to perform a method of any of aspects 16 through 25.

Aspect 30: An apparatus for wireless communications at a network entity, comprising at least one means for performing a method of any of aspects 16 through 25.

Aspect 31: A non-transitory computer-readable medium storing code for wireless communications at a network entity, the code comprising instructions executable by a processor to perform a method of any of aspects 16 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processor;
memory coupled with the processor; and
instructions stored in the memory and executable by the processor to cause the apparatus to:
receive, from a network entity, control information indicative of a characteristic of a data set used for training machine learning models at the UE, the machine learning models associated with maintaining a wireless communication link;
determine to activate or deactivate a first machine learning model for maintaining the wireless communication link or validate or invalidate a functionality of a second machine learning model for maintaining the wireless communication link based at least in part on receiving the control information; and
transmit, to the network entity, feedback information indicative of one or more parameters of the first machine learning model or the functionality of the second machine learning model based at least in part on the determining.

2. The apparatus of claim 1, wherein the instructions to receive the control information are executable by the processor to cause the apparatus to:
receive a data set identifier corresponding to the data set or a characteristic identifier corresponding to the characteristic, or both.

3. The apparatus of claim 2, wherein the instructions are further executable by the processor to cause the apparatus to:
transmit, to the network entity, an uplink message comprising one or more data set identifiers corresponding to one or more recommended data sets, one or more characteristic identifiers corresponding to one or more recommended characteristics, or both, wherein the control information is based at least in part on the uplink message.

4. (canceled)

5. The apparatus of claim 1, wherein the characteristic comprises an operation scenario for the wireless communication link, a profile characteristic of the wireless communication link, a parameter of a cell serving the wireless communication link, a transmit parameter used for downlink communications via the wireless communication link, a transmit parameter used for uplink communications via the wireless communication link, or a distance between the network entity and the UE.

6. The apparatus of claim 1, wherein the first machine learning model and the second machine learning model each comprise a respective beam prediction machine learning model based at least in part on the data set being used for training beam prediction machine learning models.

7. (canceled)

8. The apparatus of claim 1, wherein the instructions to receive the control information are executable by the processor to cause the apparatus to:
receive radio resource control layer signaling, physical layer signaling, medium access control layer signaling, or application layer signaling that comprises the control information.

9. The apparatus of claim 1, wherein the instructions to transmit the feedback information are executable by the processor to cause the apparatus to:
transmit an indication of a correspondence between the one or more parameters and the characteristic.

10. The apparatus of claim 9, wherein the instructions are further executable by the processor to cause the apparatus to:
identify the one or more parameters in response to the determining and based at least in part on the correspondence between the one or more parameters and the characteristic, wherein the feedback information indicates activation or deactivation of the first machine learning model at the UE or validation or invalidation of the functionality of the second machine learning model at the UE.

11. The apparatus of claim 1, wherein the instructions to transmit the feedback information are executable by the processor to cause the apparatus to:
transmit an indication of the one or more parameters.

12. The apparatus of claim 1, wherein the instructions are further executable by the processor to cause the apparatus to:
activate or deactivate the first machine learning model in association with the characteristic of the data set.

13. The apparatus of claim 12, wherein the instructions are further executable by the processor to cause the apparatus to:
predict a transmit beam at the network entity or a receive beam at the UE for maintaining the wireless communication link using the first machine learning model based at least in part on activating the first machine learning model, wherein the data set is used for training beam prediction machine learning models.

14. The apparatus of claim 1, wherein the instructions are further executable by the processor to cause the apparatus to:
validate or invalidate the functionality of the second machine learning model in association with the characteristic of the data set.

15. The apparatus of claim 14, wherein the instructions are further executable by the processor to cause the apparatus to:
predict a transmit beam at the network entity or a receive beam at the UE for maintaining the wireless communication link using the second machine learning model based at least in part on validating the functionality of the second machine learning model, wherein the data set is used for training beam prediction machine learning models.

16. An apparatus for wireless communications at a network entity, comprising:
a processor;
memory coupled with the processor; and
instructions stored in the memory and executable by the processor to cause the apparatus to:
output control information indicative of a characteristic of a data set used for training machine learning models at a user equipment (UE), the machine learning models associated with maintaining a wireless communication link; and
obtain, in response to the control information, feedback information indicative of one or more parameters of a first machine learning model or a functionality of a second machine learning model based at least in part on a determination to activate or deactivate the first machine learning model for maintaining the wireless communication link or validate or invalidate a functionality of the second machine learning model for maintaining the wireless communication link.

17-20. (canceled)

21. The apparatus of claim 16, wherein the first machine learning model and the second machine learning model each comprise a respective beam prediction machine learning model based at least in part on the data set being used for training beam prediction machine learning models.

22. (canceled)

23. The apparatus of claim 16, wherein the instructions to output the control information are executable by the processor to cause the apparatus to:
output radio resource control layer signal, physical layer signaling, medium access control layer signaling, or application layer signaling that comprises the control information.

24. The apparatus of claim 16, wherein the instructions to obtain the feedback information are executable by the processor to cause the apparatus to:
obtain an indication of a correspondence between the one or more parameters and the characteristic.

25. (canceled)

26. A method for wireless communications at a user equipment (UE), comprising:
receiving, from a network entity, control information indicative of a characteristic of a data set used for training machine learning models at the UE, the machine learning models associated with maintaining a wireless communication link;
determining to activate or deactivate a first machine learning model for maintaining the wireless communication link or validate or invalidate a functionality of a second machine learning model for maintaining the wireless communication link based at least in part on receiving the control information; and
transmit, to the network entity, feedback information indicative of one or more parameters of the first machine learning model or the functionality of the second machine learning model based at least in part on the determining.

27. The method of claim 26, wherein receiving the control information comprises:
receiving a data set identifier corresponding to the data set or a characteristic identifier corresponding to the characteristic, or both.

28. The method of claim 27, further comprising:
transmitting, to the network entity, an uplink message comprising one or more data set identifiers corresponding to one or more recommended data sets, one or more characteristic identifiers corresponding to one or more recommended characteristics, or both, wherein the control information is based at least in part on the uplink message.

29-30. (canceled)
